(19) United States
(12) Patent Application Publication
(10) Pub. No.: US 2025/0002212 A1
(43) Pub. Date: Jan. 2, 2025

(54) Modular Storage System with Side Mounts

(71) Applicant: Milwaukee Electric Tool Corporation, Brookfield, WI (US)

(72) Inventors: Charlie G. Noble, New Berlin, WI (US); Evan Maverick James Quiros, Houston, TX (US); David R. Hillenbrand, Grafton, WI (US); Michael R. Holtz, Milwaukee, WI (US)

(21) Appl. No.: 18/761,986

(22) Filed: Jul. 2, 2024

Related U.S. Application Data
(63) Continuation of application No. PCT/US24/34980, filed on Jun. 21, 2024.
(60) Provisional application No. 63/510,557, filed on Jun. 27, 2023.
(60) Provisional application No. 63/651,526, filed on May 24, 2024.

(51) Int. Cl. B65D 21/02

(52) U.S. Cl. CPC B65D 21/0201; B65D 21/0224

(57) ABSTRACT

One or more adapters for a modular system are provided. The adapters are configured to couple externally to utility modules in a system, such as modular tool storage units to provide access to tool storage devices, tool, and/or tool accessories. One or more support rails for a modular system are provided. The support rails are configured to couple externally to utility modules in a system, thereby providing access to tools, tool accessories, and/or storage devices.

### CROSS-REFERENCE TO RELATED PATENT APPLICATIONS

The present application is a continuation of International Application No. PCT/US2024/034980 filed on Jun. 21, 2024, which claims the benefit of and priority to U.S. Provisional Application No. 63/510,557 filed on Jun. 27, 2023, and to U.S. Provisional Application No. 63/651,526 filed on May 24, 2024, which are incorporated herein by reference in their entireties.

### BACKGROUND OF THE INVENTION

The present invention relates generally to the field of the field of containers and related devices. The present disclosure relates specifically to adapters and side support structures (e.g., side support rails) configured to support and detachably couple various items, such as materials, tools and/or tool accessories, to external side surfaces of utility modules (e.g., units) within a modular system.

Tool storage units are often used to transport tools and tool accessories. Some storage units are designed to incorporate into a modular storage system. Various adapters and support structures can be configured to couple externally to units within a modular system making tools and tool accessories available in a working environment with the tools and/or tool accessories storable within the units for transport.

### SUMMARY OF THE INVENTION

One embodiment of the invention relates to an adapter system for a utility module. The adapter system includes an adapter with a front piece and a rear clamp. The front piece includes a body extending along a longitudinal axis of the adapter and one or more recessed sections positioned along the body. The rear clamp rotatably couples to the front piece. The adapter include an engagement end and a clamping end opposing the engagement end. The adapter further includes a bore defined by the front piece and the rear clamp. The bore is positioned at the clamping end. The bore is configured to engage a corner post of the utility module.

Another embodiment of the invention relates to a utility module system. The utility module system includes a utility module and a pair of adapters. The utility module includes a plurality of corners, the plurality of corners including upper and lower corners and a side extend between the connecting the plurality of corners. The utility module further includes a plurality of corner posts extend between and connecting the upper corners and the lower corners. Each adapter of the pair of adapters is coupled to one of the plurality of corner posts. Each adapter includes a first piece and a clamp. The first piece includes a longitudinally extending body extending along the side of the utility module and a recessed section extending along the longitudinally extending body. The clamp is rotatably coupled to the first piece. Each adapter further includes an engagement end and a clamping end opposing the engagement end.

Another embodiment of the invention relates a side mount structure for a utility module. The side mount structure includes a first engagement end, a second engagement end, and a longitudinally extending body extending between and connecting the first engagement end and the second engagement end. The side mount structure further includes a first wall extending outward from the longitudinally extending body, a second wall extending outward from the longitudinally extending body, and a gate. A storage compartment is defined between the first wall, the second wall, and the gate. The gate is pivotable downward from a bottom surface of the first wall or the second wall. The first engagement end and second engagement end are configured to coupled to a utility module.

In a specific embodiment, a pair of adapters are coupled to adjacent corner posts of the utility module. Each of the longitudinally extending bodies extends along a side of the utility module. A space is defined between the engagement ends of the pair of adapters. When the pair of adapters are coupled to the storage device, the storage device extends between and couples to the one or more recessed sections of each adapter. In a specific embodiment, the storage device is an accessory rail.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a utility module, according to an exemplary embodiment.

FIG. 2 is a perspective view of a utility module, according to another exemplary embodiment.

FIG. 3 is a perspective view of a utility module, according to another exemplary embodiment.

FIG. 4 is a detailed perspective view of an adapter and rail coupled to a utility module, according to an exemplary embodiment.

FIG. 5 is a detailed perspective view of the adapter and rail coupled to the utility module, according to another exemplary embodiment.

FIG. 6 is a detailed perspective view of the adapter and rail coupled to the utility module, according to another exemplary embodiment.

FIG. 7 is a detailed perspective view of the rail coupled to the utility module, according to another exemplary embodiment.

FIG. 8 is a front perspective view of the adapter, according to an exemplary embodiment.

FIG. 9 is a rear perspective view of the adapter of FIG. 8, according to an exemplary embodiment.

FIG. 10 is an exploded view of the adapter of FIG. 8, according to an exemplary embodiment.

FIG. 11 is a rear perspective view of the adapter of FIG. 8 with the clamping end in an open position, according to an exemplary embodiment.

FIG. 12 is a front perspective view of a clip rail, according to an exemplary embodiment.

FIG. 13 is a rear perspective view of the clip rail of FIG. 12, according to an exemplary embodiment.

FIG. 14 is a front perspective view of the rail with rear clamps removed, according to an exemplary embodiment.

FIG. 15 is a top view of the rail of FIG. 14, according to an exemplary embodiment.

FIG. 16 is a front perspective view of a rail coupled to a utility module, according to an exemplary embodiment.

FIG. 17 is a front perspective view of a rail coupled to a utility module, according to another exemplary embodiment.

FIG. 18 is a front perspective view of a rail coupled to a utility module, according to another exemplary embodiment.

FIG. 19 is a perspective view of an adapter, according to another exemplary embodiment.

FIG. 20 is a perspective view of an adapter, according to another exemplary embodiment.

FIG. 21 is a perspective view of an adapter, according to another exemplary embodiment.

FIG. 22 is a perspective view of an adapter, according to another exemplary embodiment.

FIG. 23 is a perspective view of an adapter, according to another exemplary embodiment.

FIG. 24 is a perspective view of an adapter, according to another exemplary embodiment.

FIG. 25 is a perspective view of an adapter, according to another exemplary embodiment.

FIG. 26 is a detailed perspective view of a rail with female couplers that is coupled to a utility module, according to an exemplary embodiment.

FIG. 27 is a detailed perspective view of a rail with female couplers that is coupled to a utility module, according to another exemplary embodiment.

FIG. 28 is a detailed perspective view of a rail with female couplers that is coupled to a utility module, according to another exemplary embodiment.

FIG. 29 is a detailed perspective view of a rail with female couplers that is coupled to a utility module, according to another exemplary embodiment.

FIG. 30 is a detailed perspective view of a rail with female couplers that is coupled to a utility module, according to another exemplary embodiment.

FIG. 31 is a front view of a rail with female couplers, according to another exemplary embodiment.

FIG. 32 is a detailed perspective view of a rail that is coupled to a utility module, according to another exemplary embodiment.

FIG. 33 is a detailed perspective view of a rail that is coupled to a utility module, according to another exemplary embodiment.

FIG. 34 is a detailed perspective view of a rail that is coupled to a utility module, according to another exemplary embodiment.

FIG. 35 is a front view of a rail with female couplers, according to another exemplary embodiment.

FIG. 36 is a side view of a tool caddy coupled to a utility module, according to an exemplary embodiment.

FIG. 37 is a side view of a tool caddy coupled to a utility module, according to another exemplary embodiment.

FIG. 38 is a side view of a tool caddy coupled to a utility module, according to another exemplary embodiment.

FIG. 39 is a side view of the tool caddy of FIG. 38 coupled to a utility module in a closed position, according to an exemplary embodiment.

FIG. 40 is a side view of the tool caddy of FIG. 38 coupled to a utility module in an open position, according to an exemplary embodiment.

FIG. 41 is a perspective view of an internal adapter coupled to a utility module, according to an exemplary embodiment.

FIG. 42 is a perspective view of an internal adapter coupled to a utility module, according to another exemplary embodiment.

FIG. 43 is a front perspective view of the internal adapter, according to an exemplary embodiment.

FIG. 44 is a rear perspective view of the internal adapter of FIG. 43, according to an exemplary embodiment.

FIG. 45 is a perspective view of an accessory rail coupled to a utility module, according to an exemplary embodiment.

FIG. 46 is a perspective view of the accessory rail of FIG. 46 coupled externally to the utility module, according to an exemplary embodiment.

FIG. 47 is a perspective view of an internal adapter, according to another exemplary embodiment.

FIG. 48 is a perspective view of an internal adapter, according to another exemplary embodiment.

FIG. 49 is a perspective view of an internal adapter, according to another exemplary embodiment.

FIG. 50 is a perspective view the internal adapter of FIG. 48 coupled to a storage device, according to an exemplary embodiment.

FIG. 51 is a detailed perspective view of the internal adapter and storage device of FIG. 50 coupled to an accessory rail, according to an exemplary embodiment.

FIG. 52 is top perspective view of the internal adapter, storage device, and accessory rail of FIG. 50, according to an exemplary embodiment.

FIG. 53 is a front view of an internal adapter, according to another exemplary embodiment.

FIG. 54 is front view of the internal adapter of FIG. 53 trimmed according to an exemplary embodiment.

FIG. 55 is a perspective view of the internal adapter of FIG. 54 coupled to a storage device, according to an exemplary embodiment.

FIG. 56 is front view of the internal adapter of FIG. 53 trimmed according to another exemplary embodiment.

FIG. 57 is a perspective view of the internal adapter of FIG. 56 coupled to a storage device, according to an exemplary embodiment.

FIG. 58 is front view of the internal adapter of FIG. 53 trimmed according to another exemplary embodiment.

FIG. 59 is a perspective view of the internal adapter of FIG. 58 coupled to a storage device, according to an exemplary embodiment.

FIG. 60 is a perspective view of an internal adapter coupled to a storage device, according to another exemplary embodiment.

FIG. 61 is a cross-sectional view of the storage device of FIG. 60, according to an exemplary embodiment.

FIG. 62 is a front perspective view of an internal adapter, according to another exemplary embodiment.

FIG. 63 is a front perspective view of an internal adapter, according to another exemplary embodiment.

FIG. 64 is a front perspective view of an internal adapter, according to another exemplary embodiment.

FIG. 65 is a front perspective view of an internal adapter, according to another exemplary embodiment.

FIG. 66 is a perspective view of an internal adapter, according to another exemplary embodiment.

FIG. 67 is a perspective view of the internal adapter of FIG. 66 coupled to a storage device, according to an exemplary embodiment.

FIG. 68 is a perspective view of the internal adapter of FIG. 66 coupled to another storage device, according to an exemplary embodiment.

FIG. 69 is a perspective view of the internal adapter of FIG. 66 coupled to another storage device and an accessory rail, according to an exemplary embodiment.

FIG. 70 is a perspective view of the internal adapter of FIG. 66 coupled to a storage device and another accessory rail, according to an exemplary embodiment.

FIG. 71 is a perspective view of the internal adapter of FIG. 66 coupled to a storage device and another accessory rail, according to an exemplary embodiment.

FIG. 72 is a storage device with an external attachment structure, according to an exemplary embodiment.

FIG. 73 is a storage device with an external attachment structure, according to another exemplary embodiment.

FIG. 74 is a storage device with an external attachment structure, according to another exemplary embodiment.

FIG. 75 is a perspective view of an adapter, according to another exemplary embodiment.

FIG. 76 is a top perspective view of the adapter of FIG. 75, according to an exemplary embodiment.

FIG. 77 is a rear perspective view of the adapter of FIG. 75, according to an exemplary embodiment.

FIG. 78 is a rear perspective view of the adapter of FIG. 75, according to an exemplary embodiment.

FIG. 79 is a detailed perspective view of a clamping end of the adapter of FIG. 75, according to an exemplary embodiment.

FIG. 80 is a front perspective view of an accessory rail, according to another exemplary embodiment.

FIG. 81 is a rear perspective view of the accessory rail of FIG. 80, according to an exemplary embodiment.

FIG. 82 is a bottom perspective view of the accessory rail of FIG. 80, according to an exemplary embodiment.

FIG. 83 is a detailed perspective view of a portion of the accessory rail of FIG. 80, according to an exemplary embodiment.

FIG. 84 is a front perspective view of the accessory rail of FIG. 80 with hooks in a first position, according to another exemplary embodiment.

FIG. 85 is a front perspective view of the accessory rail of FIG. 80 with hooks in a second position, according to another exemplary embodiment.

FIG. 86 is a perspective view of the accessory rail of FIG. 80 with hooks in a third position, according to another exemplary embodiment.

FIG. 87 is a front perspective view of an accessory rail, according to another exemplary embodiment.

FIG. 88 is a rear perspective view of the accessory rail of FIG. 87, according to an exemplary embodiment.

FIG. 89 is a side perspective view of the accessory rail of FIG. 87, according to an exemplary embodiment.

FIG. 90 is a bottom perspective view of the accessory rail of FIG. 87, according to an exemplary embodiment.

FIG. 91 is a detailed perspective view of a portion of the accessory rail of FIG. 87 with a gate in a first position, according to an exemplary embodiment.

FIG. 92 is a detailed perspective view of a portion of the accessory rail of FIG. 87 with the gate in a second position, according to an exemplary embodiment.

FIG. 93 is a perspective view of the gate of the accessory rail of FIG. 87, according to an exemplary embodiment.

FIG. 94 is a front perspective view of an accessory rail, according to another exemplary embodiment.

FIG. 95 is a top, front perspective view of the accessory rail of FIG. 94, according to an exemplary embodiment.

FIG. 96 is a rear perspective view of the accessory rail of FIG. 94, according to an exemplary embodiment.

FIG. 97 is a bottom perspective view of the accessory rail of FIG. 94, according to an exemplary embodiment.

FIG. 98 is a front perspective view of an accessory rail, according to another exemplary embodiment.

FIG. 99 is a top, front perspective view of the accessory rail of FIG. 98, according to an exemplary embodiment.

FIG. 100 is a top perspective view of the accessory rail of FIG. 98 with dividers in a first position, according to an exemplary embodiment.

FIG. 101 is a top perspective view of the accessory rail of FIG. 98 with dividers in a second position, according to an exemplary embodiment.

FIG. 102 is a top, rear perspective view of the accessory rail of FIG. 98 with dividers in the second position, according to an exemplary embodiment.

FIG. 103 is a top, rear perspective view of the accessory rail of FIG. 98 with dividers in the first position, according to an exemplary embodiment

FIG. 104 is a front perspective view of an accessory rail, according to another exemplary embodiment.

FIG. 105 is a front perspective view of the accessory rail of FIG. 104 with an adapter removed, according to an exemplary embodiment.

FIG. 106 is a rear perspective view of the accessory rail of FIG. 104, according to an exemplary embodiment.

FIG. 107 is a rear perspective view of a portion of the accessory rail of FIG. 104 with the adapter removed, according to an exemplary embodiment.

FIG. 108 is a front perspective view of an accessory rail, according to another exemplary embodiment.

FIG. 109 is a rear perspective view of the accessory rail of FIG. 108, according to an exemplary embodiment.

FIG. 110 is a detailed perspective view of the accessory rail of FIG. 108, according to an exemplary embodiment.

FIG. 111 is a front perspective view of an accessory rail in a first orientation, according to another exemplary embodiment.

FIG. 112 is a top, front perspective view of the accessory rail of FIG. 111, according to an exemplary embodiment.

FIG. 113 is a front perspective view of an accessory rail in a second orientation, according to another exemplary embodiment.

FIG. 114 is a top, front perspective view of the accessory rail of FIG. 113, according to an exemplary embodiment.

FIG. 115 is a rear perspective view of the accessory rail of FIG. 111 in the second orientation, according to an exemplary embodiment.

FIG. 116 is a top, rear perspective view of the accessory rail of FIG. 111 in the second orientation, according to an exemplary embodiment.

FIG. 117 is a rear perspective view of the accessory rail of FIG. 111 in the first orientation, according to an exemplary embodiment.

FIG. 118 is a right side perspective view of a modular system including utility modules and accessory rails, according to an exemplary embodiment.

FIG. 119 is a left side perspective view of a modular system including utility modules and accessory rails, according to another exemplary embodiment.

FIG. 120 is a perspective view of adapters coupled to a utility modules, according to an exemplary embodiment.

FIG. 121 is a front perspective view of an accessory rail, according to another exemplary embodiment.

FIG. 122 is a rear perspective view of the accessory rail of FIG. 121, according to an exemplary embodiment.

FIG. 123 is a cross-sectional view of the accessory rail taken along line 123-123 in FIG. 122, according to an exemplary embodiment.

### DETAILED DESCRIPTION

Referring generally to the figures, various embodiments of adapters and side mount structures for use with a modular system are shown according to exemplary embodiments. The adapters and side mount structures are configured to couple externally to units or modules within the modular system making tools and tool accessories available in a working environment with the tools and/or tool accessories storable within the units for transport. The adapters and side mount structures are configured to couple to the utility modules without widening the modules. Applicant has developed various adapters discussed herein that are couplable to the exterior of modules and usable with a variety of storage devices (e.g., hooks, tool pouches, clip rails, etc.) that span between the adapters. The storage devices make tools and tool accessories available in a working environment and are easily removable to allow for repositioning of the storage devices, tools and/or tool accessories within the module for transport.

Additionally, Applicant has developed various side mount systems or structures configured to couple externally to the utility modules. The side mount structures include a plurality of engagement locations for coupling and support of storage devices. In a specific embodiment, the engagement locations are defined by a plurality of projections spaced along the side mount structure to allow for convenient positioning of storage devices, tools and/or tool accessories along a side of the module. Specifically, the side mount structure is configured for smaller devices (e.g., single hooks, etc.) to be placed anywhere along the span of the side mount structure.

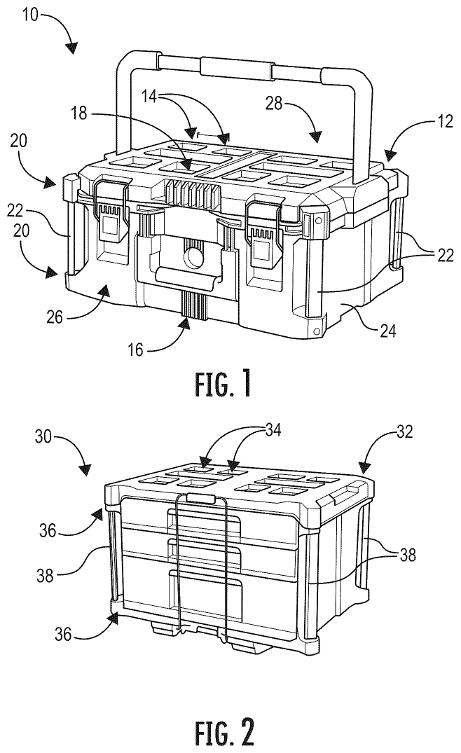

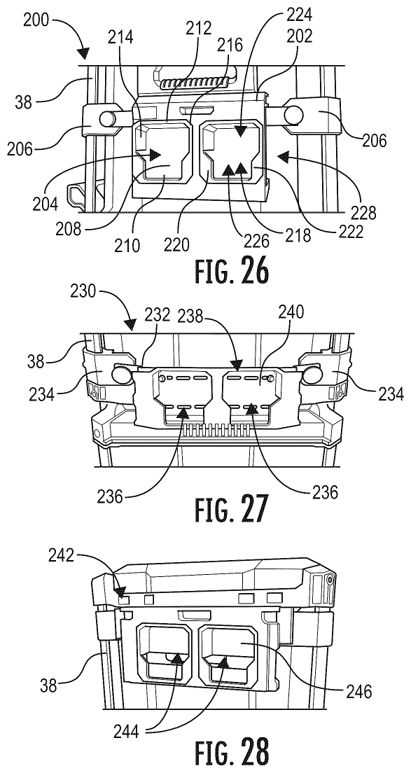

Referring to FIG. 1, various aspects of utility module 10 are shown, according to an exemplary embodiment. Utility module 10 includes an upper surface 12 and an opposing lower surface 24 facing away from the upper surface 12. One or more female couplers 14 extend from and/or are located in upper surface 12 of utility module 10, and one or more male couplers configured to engage female couplers 14 extend from lower surface 24 of utility module 10. Female couplers 14 are substantially the same as female couplers 204 (see e.g., FIG. 26) except for the differences discussed herein. Utility module 10 includes a latch 16 and a latch recess 18 configured to interface with latch recesses 18 and latches 16, respectively, to secure utility module 10 to other objects and/or utility modules.

Utility module 10 includes a plurality of corners 20. In various embodiments, corners 20 define outermost edges of utility module 10. In various specific embodiments, corners 20 are reinforced with a material such as metal. Utility module 10 further includes a plurality of corner posts or pillars 22 extending between and connecting opposing upper and lower corners 20. In various specific embodiments, corner posts 22 are formed from aluminum and are aluminum extrusion posts. In various specific embodiments, each corner 20 of utility module 10 includes a corner post 22 such that there are four corner posts 22.

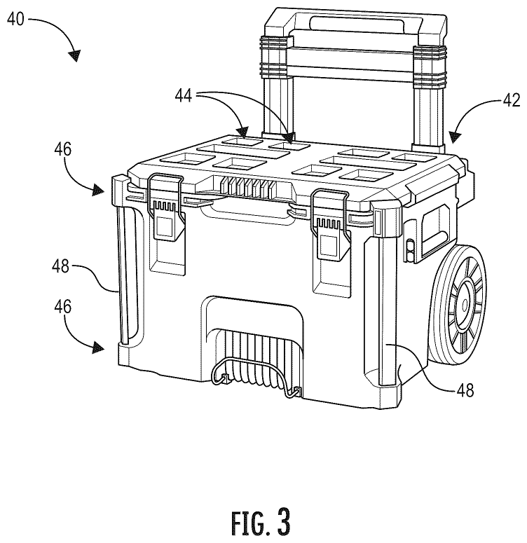

Referring to FIG. 2, details of a utility module 30 are shown according to an exemplary embodiment. Utility module 30 is substantially the same as utility module 10 except for the differences discussed herein. Utility module 30 includes an upper surface 32 with one or more female couplers 34 extend from and/or are located in upper surface 32 of utility module 30. Utility module 30 includes a plurality of corners 36 and a plurality of corner posts or pillars 38 extending between and connecting opposing upper and lower corners 36. Referring to FIG. 3, details of a utility module 40 are shown according to an exemplary embodiment. Utility module 40 is substantially the same as utility modules 10, 30 except for the differences discussed herein. Utility module 40 includes an upper surface 42 with one or more female couplers 44 extend from and/or are located in upper surface 42 of utility module 40. Utility module 40 includes a plurality of corners 46 and a plurality of corner posts or pillars 48 extending between and connecting opposing upper and lower corners 46. In various specific embodiments, half of the corners 46 of utility module 40 include a corner post 48 such that there are two corner posts 48.

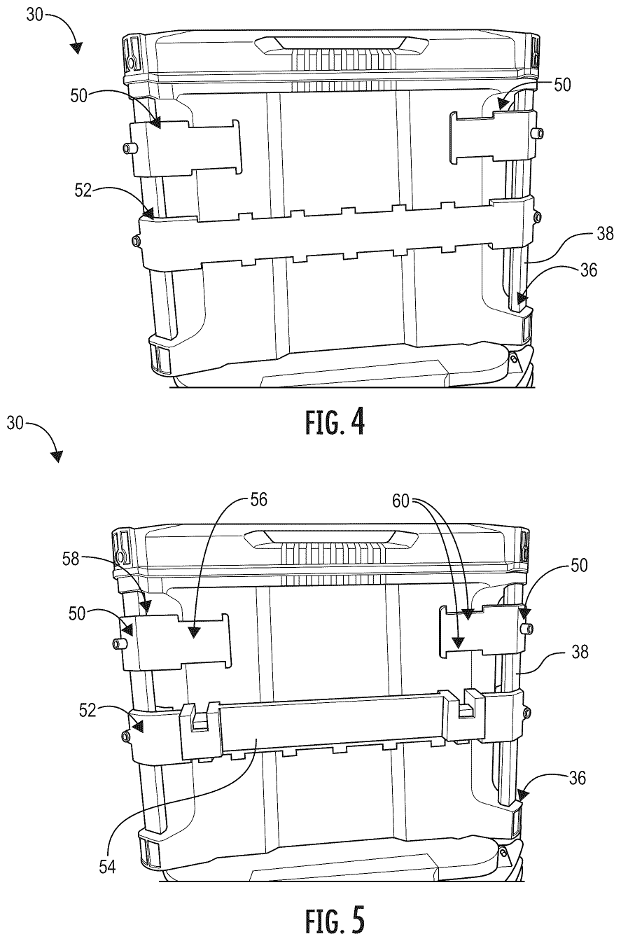

Referring to FIGS. 4-7, side views of various utility modules 10, 30, 40 with side mount systems, shown as an adapter 50 and/or side mount structure, shown as rail 52 are shown according to exemplary embodiments. In other words, various side mount systems such including adapter(s) 50 and rail(s) 52 for utility modules (e.g., 10, 30, 40) will be discussed herein. As noted above, adapters 50 and/or rails 52 do not add width to the utility modules 10, 30, 40. In other words, the corners 20, 36, 46 define the outermost or widest portions of the utility modules 10, 30, 40. Adapters 50 are couplable to corner posts 22, 38, 48 of utility modules 10, 30, 40 and positionable such that they do not block a handle, the front, and/or rear of the utility module 10, 30, 40 such that a user can access the inside of the utility module 10, 30, 40.

In various embodiments, a pair of adapters 50 are coupled to adjacent corner posts 22, 38, 48 such that the adapters 50 are positioned along a side (i.e., wall between front and rear of module) of the utility module 10, 30, 40. In other embodiments, a pair of adapters 50 are coupled to adjacent corner posts 22, 38, 48 such that the adapters 50 are positioned along a front (see e.g., 26 in FIG. 1) or rear (see e.g., 28 in FIG. 1) of the utility module 10, 30, 40. Adapters 50 have a length such that there is a space or gap between the adapters 50. In other words, engagement ends 56 of a pair of adapters 50 coupled to adjacent corner posts 22 are separated by a distance such that the engagement ends 56 are not in contact with each other.

Each adapter 50 includes a clamping end 58 configured to extend around and grasp or hold the corner posts 22, 38, 48 and an opposing engagement end 56. The engagement ends 56 are configured to support or couple to a storage device. The engagement end 56 includes a recessed section 60. Recessed section 60 extends inward in the direction of the minor dimension or transverse direction of adapter 50. In other words, recessed section 60 extends inward from the outer edge of the longitudinally extending body 78. In a specific embodiment, adapter 50 includes a pair of recessed sections 60 (i.e., an upper recessed section 60 and a lower recessed section 60). In various embodiments, the longitudinally extending body 78 has a first width defined in the direction transverse to the longitudinal axis (i.e., between outer edges). In such embodiments, the recessed sections 60 have a second width that is less than the first width. In various embodiments, tabs 76 of adapter 50 have a third width that is the same as the first width. In various embodiments, the tabs 76 may have a third width that is different than the first width or the second width.

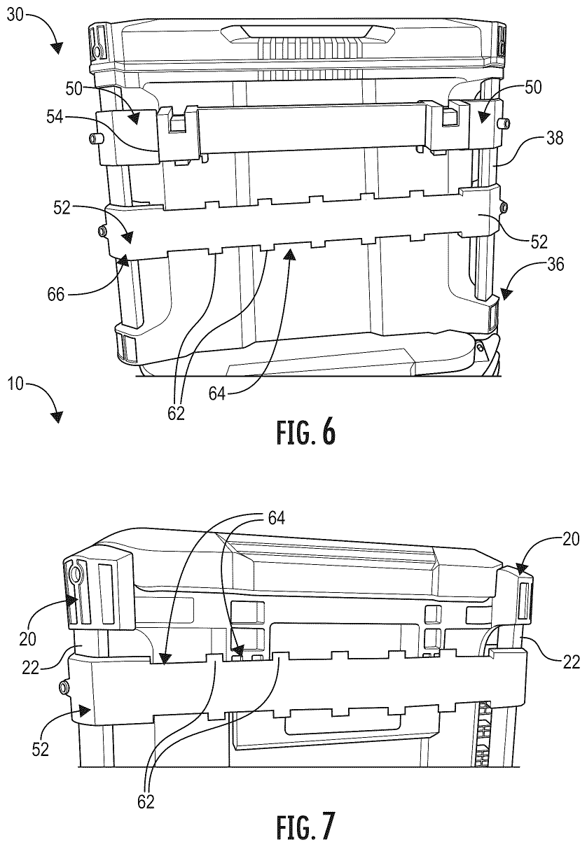

A variety of storage devices such as hooks, tool pouches, clip rails, etc. can be coupled to adapters 50 such that the storage devices span between the adapters 50. In various specific embodiments, the storage device is coupled to at least one adapter and includes at least one of a hook, tool pouch, clip rail. For example, as shown in FIG. 6 a clip rail, shown as spring loaded clip rail 54 is coupled to the pair of adapters 50 to form an adapter system. Specifically, clip rail 54 is coupled to the recessed sections 60 of each adapter 50. As will be discussed in greater detail below, various combinations of adapters such as adapter 50 and accessory rails such as clip rail 54 can be utilized to create a customized external storage for a modular system.

In various embodiments, rail 52 is coupled to adjacent corner posts 22, 38, 48 such that the rail 52 is positioned along a side (i.e., wall between front and rear of module) of the utility module 10, 30, 40. In other embodiments, the rail 52 is coupled to adjacent corner posts 22, 38, 48 such that the rail 52 is positioned along a front (see e.g., 26 in FIG. 1) or rear (see e.g., 28 in FIG. 1) of the utility module 10, 30, 40. In various embodiments, rail 52 has a length such that the rail 52 spans the entire distance between the corner posts 22, 38, 48 (i.e., there is no space or gap). Rail 52 extends between clamping ends 66. Each clamping end 66 is configured to extend around and grasp or hold a corner post 22, 38, 48.

Rail 52 includes a plurality of projections or tabs 62 spaced along the rail 52 to allow for positioning of storage devices, tools and/or tool accessories along a side of the utility module 10, 30, 40 in chosen locations. Specifically, the rail 52 is configured for smaller devices (e.g., single hooks, etc.) to be placed in a desired location along the length of rail 52. Each of the plurality of tabs 62 extends in the minor dimension or transverse direction of rail 52 (i.e., toward upper surface 12 or lower surface 24 of utility module 10). A recessed section 64 of rail 52 is positioned between adjacent tabs 62 or between a tab 62 and one of the clamping ends 66. As shown in FIG. 5, clip rail 54 can be coupled to recessed sections 64 of rail 52.

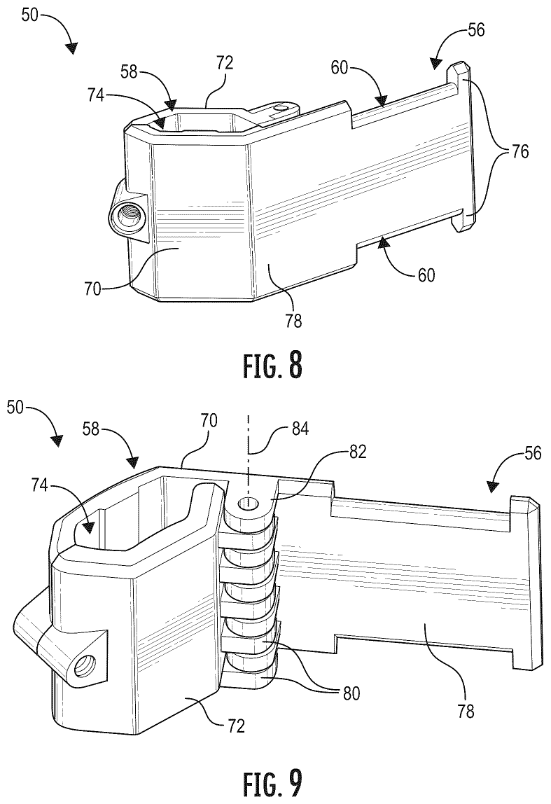

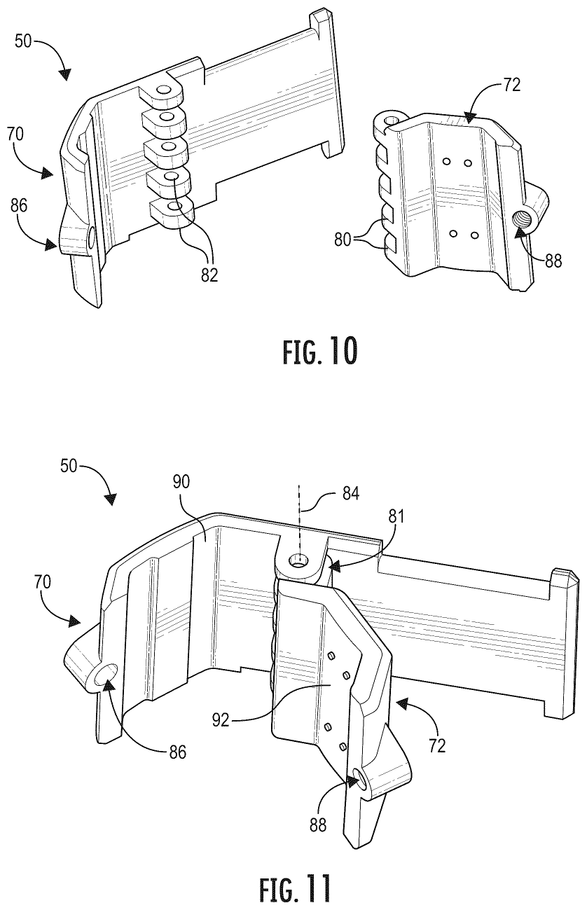

Referring to FIGS. 8-11, details of adapter 50 are shown, according to an exemplary embodiment. Each adapter 50 includes a first piece, shown as front piece 70 and second piece, shown as a rear clamp 72 rotatably coupled to front piece 70. A corner post bore 74 is defined between front piece 70 and rear clamp 72. When adapter 50 is coupled to the utility module 10, 30, 40, the corner post 22, 38, 48 is positioned within corner post bore 74.

Front piece 70 includes a longitudinally extending body 78 extending along a longitudinal axis of the adapter 50 with one or more tabs 76 positioned at the engagement end 56 of body 78 that opposes the clamping end 58. Tab 76 is positioned at a distal end of recessed section 60. Front piece 70 further includes a plurality of rearward extending (i.e., toward rear clamp 72) projections 80. Rear clamp 72 includes frontward extending (i.e., toward front piece 70) projections 82. Rearward extending projections 80 and frontward extending projections 82 together form a hinge 81 of adapter 50. Hinge 81 allows rear clamp 72 to move about an axis of rotation 84.

Front piece 70 further includes an inward facing surface 90 that interfaces against the corner post 22, 38, 48 when adapter 50 is coupled to the utility module 10, 30, 40. Similarly, rear clamp 72 includes an inward facing surface 92 that interfaces against the corner post 22, 38, 48 when adapter 50 is coupled to the utility module 10, 30, 40. Inward facing surface 90 of front piece 70 and inward facing surface 92 of rear clamp 72 together define the corner post bore 74. Front piece 70 includes a bore 86 that extends in a generally perpendicular (i.e., 90 degrees plus or minus 10 degrees) orientation to corner post bore 74. Rear clamp 72 includes a bore 88 that extends in a generally perpendicular (i.e., 90 degrees plus or minus 10 degrees) orientation to corner post bore 74. When adapter 50 is in a closed position, bore 86 of front piece 70 aligns with bore 88 of rear clamp 72. A user can couple front piece 70 to rear clamp 72 using a fastener. In a specific embodiment, bore 86 and bore 88 receive a bolt to fasten front piece 70 to rear clamp 72.

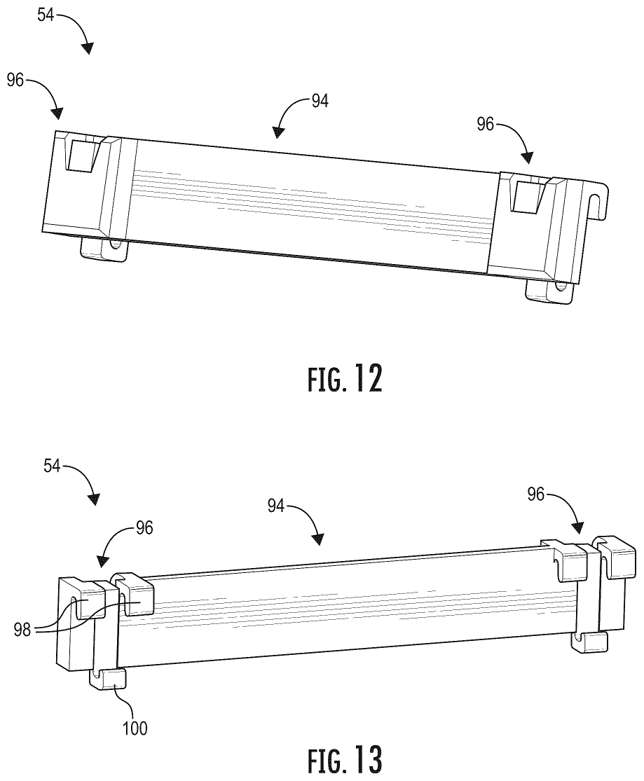

Referring to FIGS. 12-13, details of clip rail 54 are shown according to an exemplary embodiment. Clip rail 54 includes a longitudinally extending body 94 that extends between a pair of engagement ends 96. Engagement ends 96 are configured to engage with adapter 50, rail 52, and/or the utility module 10, 30, 40. Each engagement end 96 includes at least one clip 98 and a spring loaded clip 100 configured to securely couple to adapter 50, rail 52, and/or the utility module 10, 30, 40. As will be generally understood, spring loaded clip 100 includes a spring such that spring loaded clip 100 can be moved and/or pulled away from body 94 clip rail 54 in an extended position and once released, spring loaded clip 100 will move back toward body 94 of clip rail 54 to allow for secure engagement with adapter 50, rail 52, and/or the utility module 10, 30, 40.

In various embodiments, the spring loaded clip 100 has an orientation that is opposite of the clip(s) 98 such that spring loaded clip 100 faces clip 98. In other words, in various embodiments, where clip 98 includes a protrusion that extends downward, spring loaded clip 100 has a protrusion that extends in an opposite or upward (see e.g., orientation shown in FIG. 13). As will be generally understood clip(s) 98 and spring clip(s) 100 include a space positioned between the longitudinally extending body 94 and their respective protrusions. For example, when clip rail 54 is coupled to and/or engaged with adapter 50, adapter 50 is positioned in the space between longitudinally extending body 94 and the protrusions of clip(s) 98 and spring clip(s) 100.

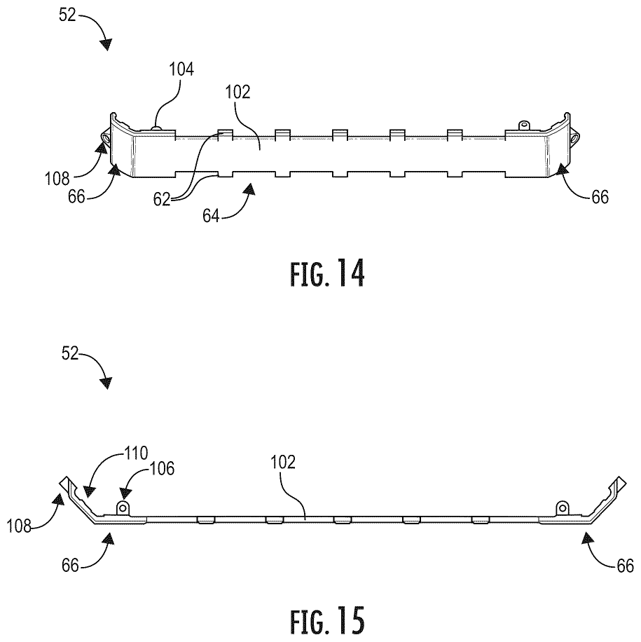

Referring to FIGS. 14-15, details of rail 52 are shown according to an exemplary embodiment. Rail 52 and specifically a longitudinally extending body 102 extends between clamping ends 66. Rail 52 further includes a rear clamp (see e.g., element 72) to allow for coupling to the corner post 22, 38, 48 of the utility module 10, 30, 40. The rear clamp is rotatably coupled to longitudinally extending body 102 and moveable about axis of rotation 104. Rail 52 includes a pair of hinges 106. Hinges 106 and the rear clamp are the same as hinge 81 and rear clamp 72 of adapter 50 except for the differences discussed herein. In various specific embodiments, the longitudinally extending body 102 and the clamping ends 66 are integrally formed as a single, unitary body.

A corner post bore 110 is defined between longitudinally extending body 102 and the rear clamp. Body 102 further includes bore 108 configured to align with a bore on the rear clamp when rail 52 is in a closed position. In a specific embodiment, bore 108 includes threads to receive a bolt to fasten body 102 to the rear clamp.

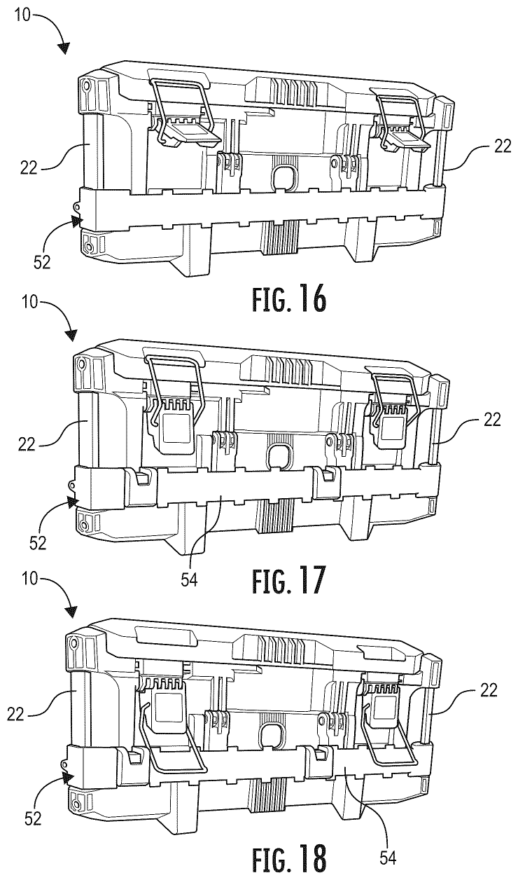

Referring to FIGS. 16-18, various embodiments of rail 52 are shown according to exemplary embodiments. Rail 52 includes a length configured to span a distance between opposing corner posts 22, 38, 38 for various utility modules 10, 30, 40. As such various embodiments of rail 52 include various lengths. Clip rail 54 is couplable to recessed sections 64 at various positions along the length of rail 52.

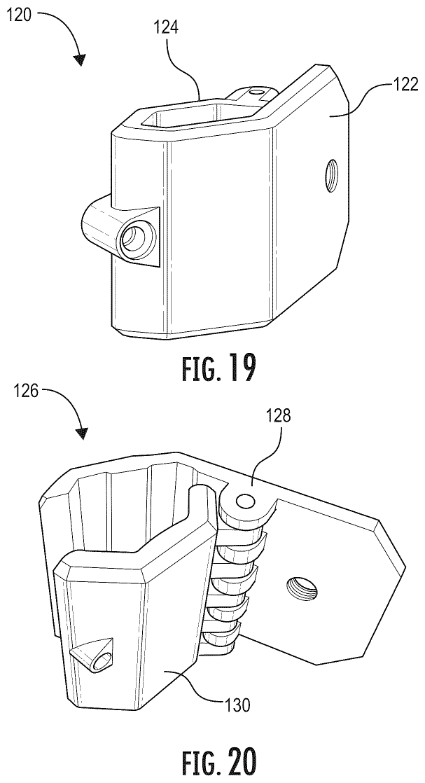

Referring to FIGS. 19-25, various adapters are shown according to exemplary embodiments. An adapter 120 is shown according to an exemplary embodiment. Adapter 120 includes a front piece 122 rotatably coupled to a rear clamp 124. Referring to FIG. 20, an adapter 126 including a front piece 128 rotatably coupled to a rear clamp 130 is shown according to another exemplary embodiment.

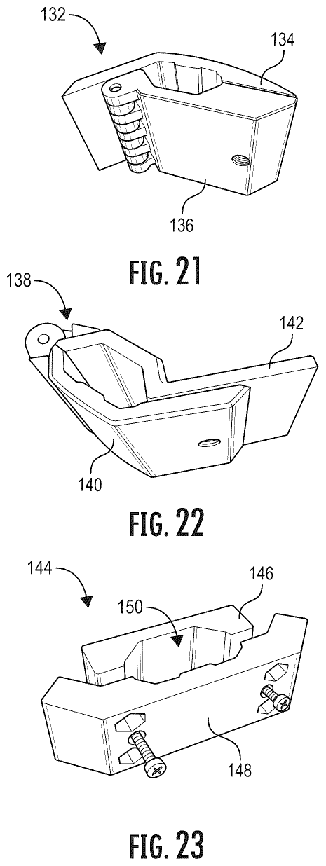

Referring to FIG. 21, an adapter 132 including a front piece 134 rotatably coupled to a rear clamp 136 is shown according to another exemplary embodiment. Referring to FIG. 22, an adapter 138 including a front piece 140 rotatably coupled to a rear clamp 142 is shown according to another exemplary embodiment. Referring to FIG. 23, an adapter 144 including a front piece 146 are a rear clamp 148 is shown according to an exemplary embodiment. A corner post bore 150 is defined between front piece 146 and rear clamp 148. Rear clamp 148 is coupled to front piece 146 by a fastener, such as a bolt, that can be tightened to couple adapter 144 to a corner post 22, 38, 48.

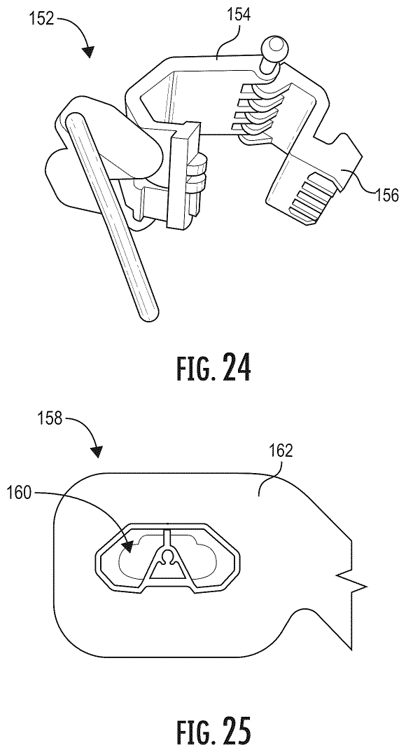

Referring to FIG. 24, an adapter 152 is shown according to another exemplary embodiment. Adapter 152 includes a front piece 154 rotatably coupled to a rear clamp 156. Referring to FIG. 25, an adapter 158 is shown according to another exemplary embodiment. Adapter 158 includes a corner post bore 160 defined and extending through a body 162 of the adapter 158.

Referring to FIGS. 26-31, various embodiments of rails including female couplers are shown, according to exemplary embodiments. In some embodiments, the rails are coupled to utility modules 10, 30, 40 using adapters such as adapters 50. In other embodiments, the rails include integrally formed engagement ends, that are substantially the same as the clamping ends 66 of rails 52 except for the differences discussed herein.

Referring to FIG. 26, a support rail 200 includes a rail body 202. Rail body 202 extends between and is coupled to a pair of adapters 206. Rail body 202 includes one or more female couplers 204. Each female coupler 204 includes a recessed surface 208, a back wall 210, opposing front wall 212, first sidewall 214, and opposing second sidewall 216 extend around female coupler 204. Female coupler 204 includes a pocket 218 collectively defined by recessed surface 208, back wall 210, front wall 212, first sidewall 214, and second sidewall 216.

First rib 220 extends from back wall 210 and first sidewall 214 above pocket 218 and/or recessed surface 208. In particular, first rib 220 extends in direction 224 from first sidewall 214 and first rib 220 extends in direction 226 from back wall 210. Second rib 222 extends from back wall 210 and second sidewall 216 above pocket 218 and/or recessed surface 208. In particular, second rib 222 extends in direction 228 from second sidewall 216 and second rib 222 extends in direction 226 from back wall 210.

Referring to FIG. 27, a support rail 230 is shown according to another exemplary embodiment. Support rail 230 includes a rail body 232. Rail body 232 extends between and is coupled to a pair of adapters 234. Rail body 232 includes one or more female couplers 236. Female couplers 236 are substantially the same as female couplers 204 except for the differences discussed herein. In various embodiments, female coupler 236 includes apertures 238. In a specific embodiment, apertures 238 are arranged in a line at an upper portion of a recessed surface 240.

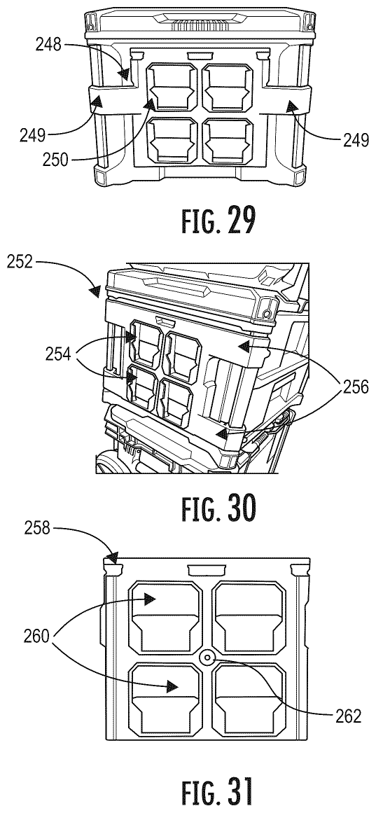

Referring to FIG. 28, a support rail 242 is shown according to another exemplary embodiment. Support rail 242 is substantially the same as support rails 200, 230 except for the differences discussed herein. Support rail 242 includes a recessed surface 246 that only extends through a portion of female coupler 244. In a specific embodiment, support rail 242 includes two female couplers 244. Referring to FIG. 29, a support rail 248 is shown according to an exemplary embodiment. Support rail 248 is substantially the same as support rail 242 except for the differences discussed herein. Support rail 248 includes two clamping ends 249 to couple to corner posts 22, 38, 48. Support rail 248 includes four female couplers 250. The female couplers 250 are arranged in a grid with two female couplers 250 in each of two rows.

Referring to FIG. 30, a support rail 252 is shown according to another exemplary embodiment. Support rail 252 includes a plurality of female couplers 254. In a specific embodiment, female couplers 254 are arranged in a grid with two female couplers 254 in each of two rows. In other words, there are four female couplers 254. Support rail 252 includes four clamping ends 256 to couple to corner posts 22, 38, 48. Referring to FIG. 31, a support rail 258 is shown according to another exemplary embodiment. Support rail 258 is substantially the same as support rails 248, 252 except for the differences discussed herein. Support rail 258 includes a plurality of female couplers 260 with a locker 262 positioned between the plurality of female couplers 260.

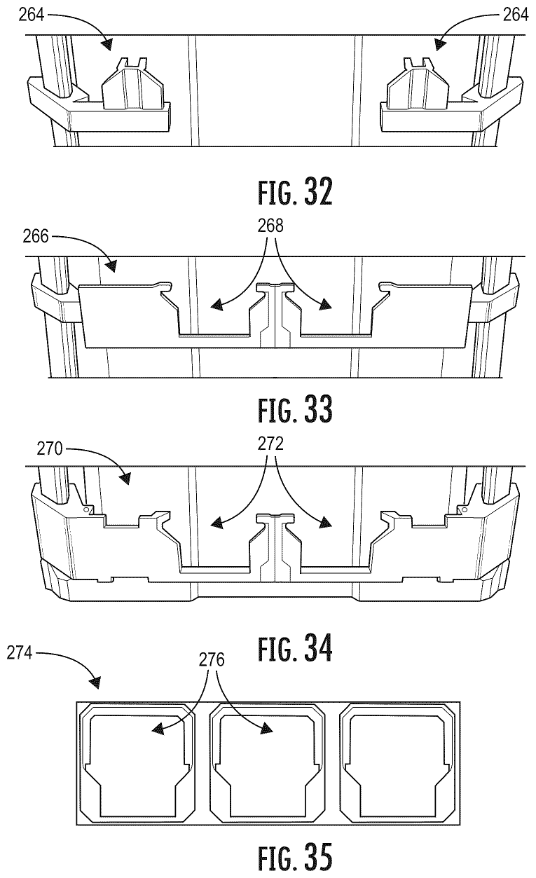

Referring to FIGS. 32-35, various embodiments of rails with some rails including female couplers are shown, according to exemplary embodiments. In some embodiments, the rails are coupled to utility modules 10, 30, 40 using adapters such as adapters 50. In other embodiments, the rails include integrally formed engagement ends, that are substantially the same as the clamping ends 66 of rails 52 except for the differences discussed herein.

Referring to FIG. 32, a pair of adapters 264 are shown according to another exemplary embodiment. Adapters 264 are configured to couple to an accessory such as a mounting plate. Referring to FIG. 33, a rail 266 is shown according to another exemplary embodiment. Rail 266 includes a portion of a female coupler 268. Portion of female coupler 268 is configured to hold tools and/or tool accessories. Referring to FIG. 34, a rail 270 is shown according to another exemplary embodiment. Rail 270 includes a portion of a female coupler 272. Portion of female coupler 272 is configured to hold tools and/or tool accessories. Referring to FIG. 35, a rail 274 is shown according to another exemplary embodiment. Rail 274 includes a plurality of a female couplers 276.

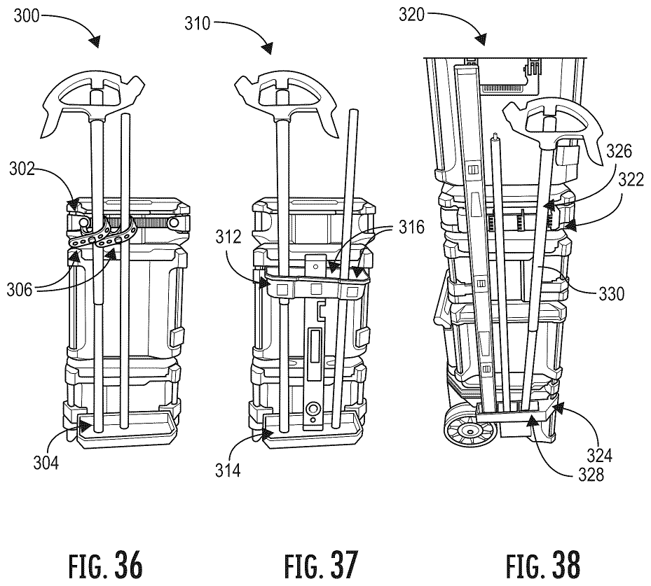

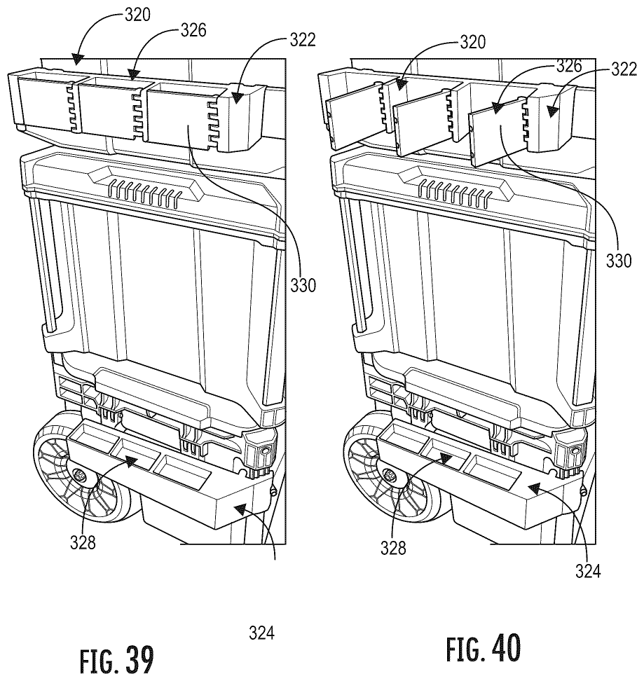

Referring to FIGS. 36-40, various embodiments of a tool caddy are shown. In some embodiments, the tool caddies are coupled to utility modules 10, 30, 40 using adapters such as adapters 50. In other embodiments, the tool caddies include integrally formed engagement ends, that are substantially the same as the clamping ends 66 of rails 52

As shown in FIG. 36, tool caddy 300 includes an upper component 302 and a lower tray component 304. Upper component 302 is coupled to a utility module stacked on one or more utility modules. Lower tray component 304 is coupled to a separate utility module lower than the utility module coupled to upper component 302. Upper component 302 includes one or more compartments 306 configured to separately receive a tool or a shaft of the tool. Lower tray component 304 is configured to receive an opposing end of the tool from the end positioned within compartment 306. Referring to FIG. 37, a tool caddy 310 is shown according to another exemplary embodiment. Tool caddy 310 is substantially the same as tool caddy 300 except for the differences discussed herein. Tool caddy 310 includes an upper component 312 and a lower tray component 314. Upper component 312 of tool caddy 310 includes a plurality of separate compartments 316.

Referring to FIGS. 38-40, a tool caddy 320 is shown according to another exemplary embodiment. Tool caddy 320 is substantially the same as tool caddies 300, 310 except for the differences discussed herein. Tool caddy 320 includes an upper component 322 and a lower tray component 324. Upper component 322 of tool caddy 310 includes a plurality of separate compartments 326 and lower tray component 324 includes a plurality of separate compartments 328. In specific embodiments, each compartment 326 includes a door 330. In various specific embodiments, doors 330 include a latch, detent, and/or snap fit for closing. In other embodiments, doors 330 are spring loaded.

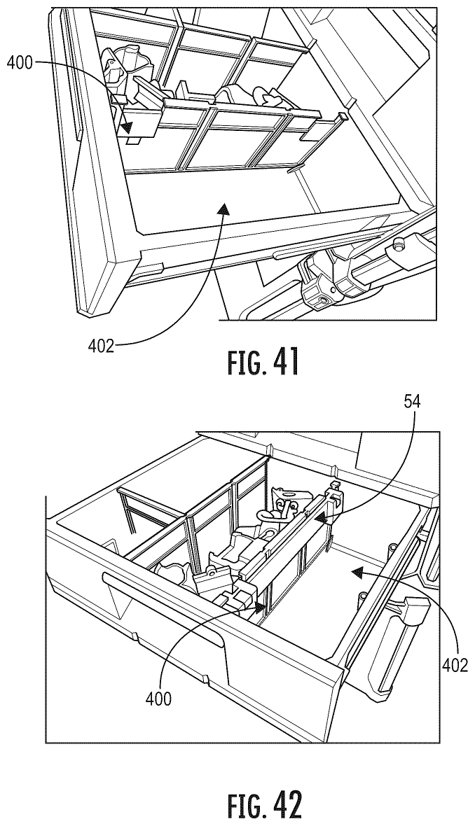

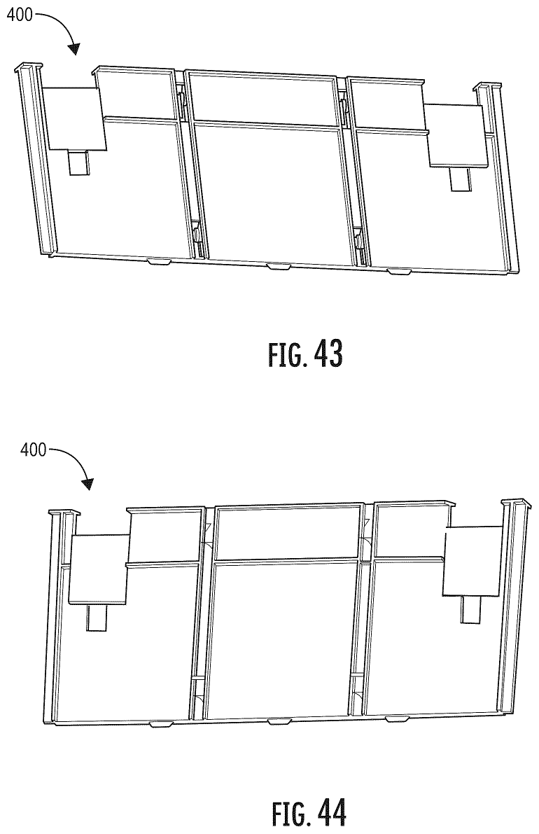

Referring to FIGS. 41-44, an internal adapter 400 coupled to a utility module, is shown according to an exemplary embodiment. Internal adapter 400 is configured to be positioned within a utility module and specifically within a cavity 402 such as the cavity of a drawer. In various specific embodiments, internal adapter 400 is a divider. Clip rail 54 can be coupled to internal adapter 400. For example, as shown in FIG. 42, clip rail 54 is coupled to rectangular cut outs positioned along the upper edge of internal adapter 400.

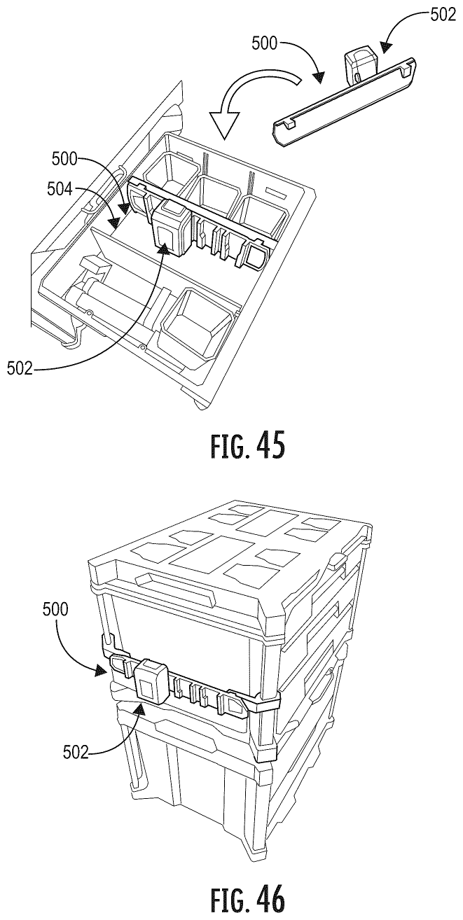

Referring to FIGS. 45-46, an accessory rail 500 is shown according to an exemplary embodiment. Accessory rail 500 is configured to couple to and support tools and/or tool accessories such as battery 502. Accessory rail 500 is positionable within a cavity 504 of a utility module 10, 30, 40 or on an external portion of the utility module 10, 30, 40 such as the corner posts 22, 38, 48.

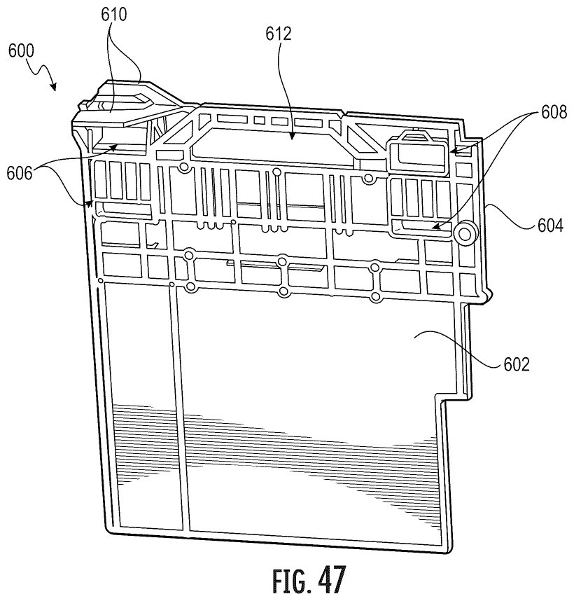

Referring to FIGS. 47-65, various embodiments an internal adapters configured to be coupled and/or positioned within utility modules are shown according to exemplary embodiments. Internal adapters 600, 620, 640, 670, 710, 720, 730, 740, and 750 are substantially the same as internal adapter 400 except for the differences discussed herein.

Referring to FIG. 47, an internal adapter, shown as divider 600 is shown according to an exemplary embodiment. Divider 600 includes a front surface 602 and a rear surface 604 that opposes front surface 602. A first pair of cutouts 606 extend through front surface 602 and rear surface 604 and are positioned along an edge of divider 600. The first pair of cutouts 606 includes a first cutout positioned above a second cutout (in the orientation shown in FIG. 47). In various specific embodiments, the pair of cutouts 606 have a generally rectangular shape. Divider 600 further includes a second pair of cutouts 608 that extend through front surface 602 and rear surface 604 and are positioned along an edge of divider 600 that opposes the edge where first cutouts 606 are positioned. The second pair of cutouts 608 includes a first cutout positioned above a second cutout (in the orientation shown in FIG. 47).

The first pair of cutouts 606 and second pair of cutouts 608 are spaced a distance apart. In various specific embodiments, the distance is the size of a gap between clips of an accessory rail. In other words, the first pair of cutouts 606 and second pair of cutouts 608 are configured to receive clips (see e.g., 90, 100 in FIG. 13) of an accessory rail such that the accessory rail can be clipped to divider 600.

In various specific embodiments, divider 600 includes a cleat wings 610 extending outward from a top edge of divider 600. Cleat wings 610 are configured to support compact stacking. In various specific embodiments, divider 600 includes a handle opening 612 extending from front surface 602 to rear surface 604.

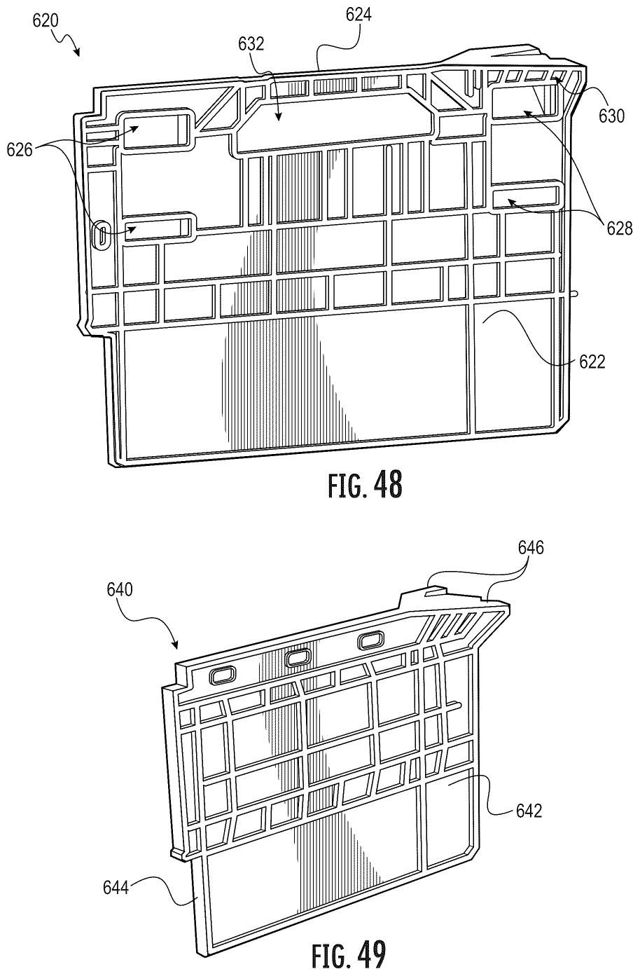

Referring to FIG. 48, details of an internal adapter, shown as divider 620 is shown according to an exemplary embodiment. Divider 620 includes a front surface 622 and a rear surface 624 that opposes front surface 622. A first pair of cutouts 626 extend through front surface 622 and rear surface 602 and are positioned along an edge of divider 620. Divider 620 further includes a second pair of cutouts 628 that extend through front surface 622 and rear surface 624 and are positioned along an edge of divider 620 that opposes the edge where first cutouts 626 are positioned. In various specific embodiments, divider 620 includes a cleat wings 630 extending outward from a top edge of divider 620. In various specific embodiments, divider 620 includes a handle opening 632 extending from front surface 622 to rear surface 624.

Referring to FIG. 49, details of an internal adapter, shown as divider 640, are shown according to another exemplary embodiment. Divider 640 includes a front surface 642 and a rear surface 644 that opposes front surface 642. In various specific embodiments, divider 640 includes a cleat wings 646 extending outward from a top edge of divider 640.

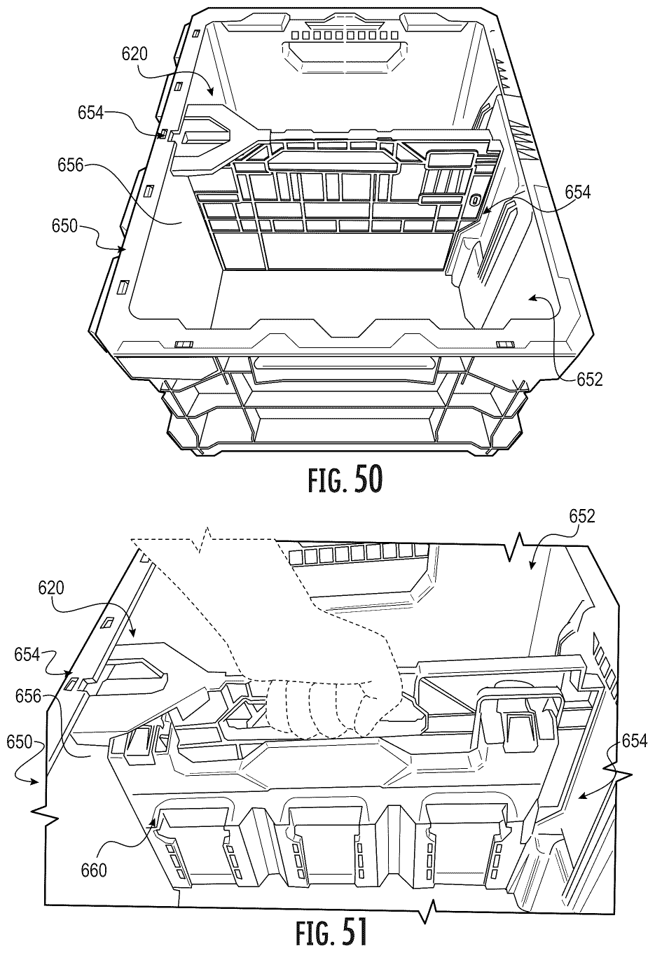

Referring to FIGS. 50-52, details of divider 620 coupled to various storage devices, are shown. Divider 620 is couplable to a storage device 650. In various specific embodiments, storage device 650 is a crate. Storage device 650 includes a cavity 652 in which divider 620 is positioned when coupled to storage device 650. Interior walls 656 define cavity 652 of storage device 650. In various specific embodiments, interior walls 656 include channels 654 configured to receive at least a portion of divider 620.

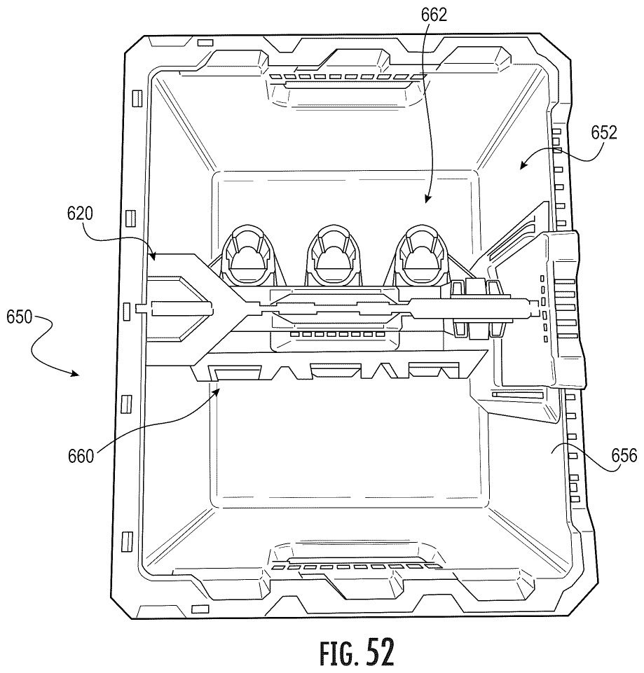

As previously discussed, divider 620 is configured to support accessory rails. As shown in FIG. 51, divider 620 supports an accessory rail 660 within cavity 652 of storage device 650. Accessory rail 660 is configured to support and couple to energy storage devices such as batteries. In specific embodiments, accessory rail 660 is sized to support 18V batteries or battery packs, such as 18V Lithium Ion batteries. As shown in FIG. 52, while accessory rail 660 is supported along one side of divider 620 another accessory rail 662 can be supported along the opposing side of divider 620. In specific embodiments, accessory rail 662 is configured to support and couple energy storage devices such as batteries. In specific embodiments, accessory rail 662 is sized to support 12V batteries or battery packs, such as 12V Lithium Ion batteries.

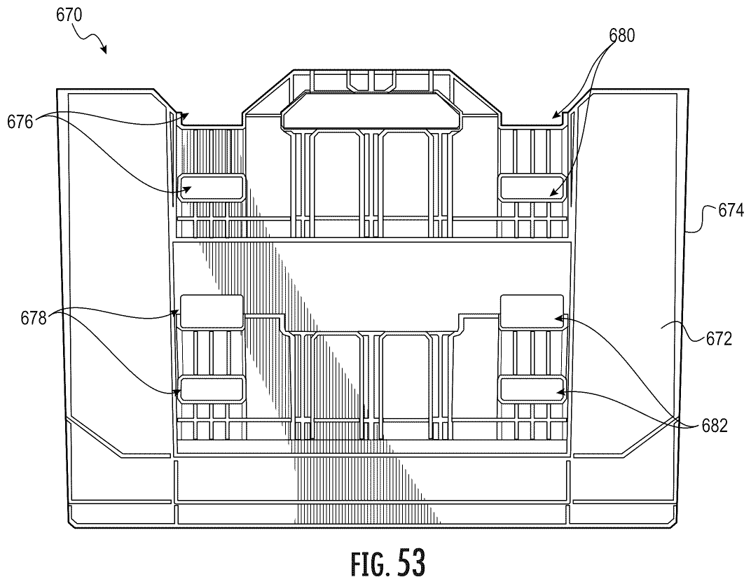

Referring to FIGS. 53-63, various embodiments, of trimmable internal dividers are shown according to exemplary embodiments. As will be generally understood, various storage devices, boxes, crates, drawers, etc. of a modular system have various dimensions of storage spaces and/or cavities. As such, in order to have internal adapters or dividers for such a modular system, the internal adapters are trimmable and/or customizable to allow for them to utilized with multiple storage devices of different dimensions.

Referring to FIG. 53, details of an internal adapter, shown as divider 670 is shown according to an exemplary embodiment. Divider 670 includes a front surface 672 and a rear surface 674 that opposes front surface 672. A first pair of cutouts 676 extend through front surface 672 and rear surface 674 and are positioned along an edge of divider 670. Divider 670 further includes a second pair of cutouts 678 that extend through front surface 672 and rear surface 674 and are positioned along the same edge of divider 670 along which first cutouts 676 are positioned.

Divider 670 further includes a third pair of cutouts 680 and a fourth pair of cutouts 682. The third and fourth pair of cutouts 680, 682 are substantially the same as the first and second pair of cutouts 676, 678 except the third and fourth pair of cutouts 680, 682 are positioned along an opposing edge of divider 670. Each pair of cutouts 676, 678, 680, 682 are spaced a distance apart from the corresponding cutout in the pair. In various specific embodiments, the distance is the size of a gap between clips of an accessory rail. In other words, the first pair of cutouts 676, second pair of cutouts 678, third pair of cutouts 680 and fourth pair of cutouts 682 are configured to receive clips (see e.g., 90, 100 in FIG. 13) of an accessory rail such that the accessory rail can be clipped to divider 600. In various embodiments, in order to be used with various storage devices divider 670 is trimmable, such that the outer dimensions of divider can be modified.

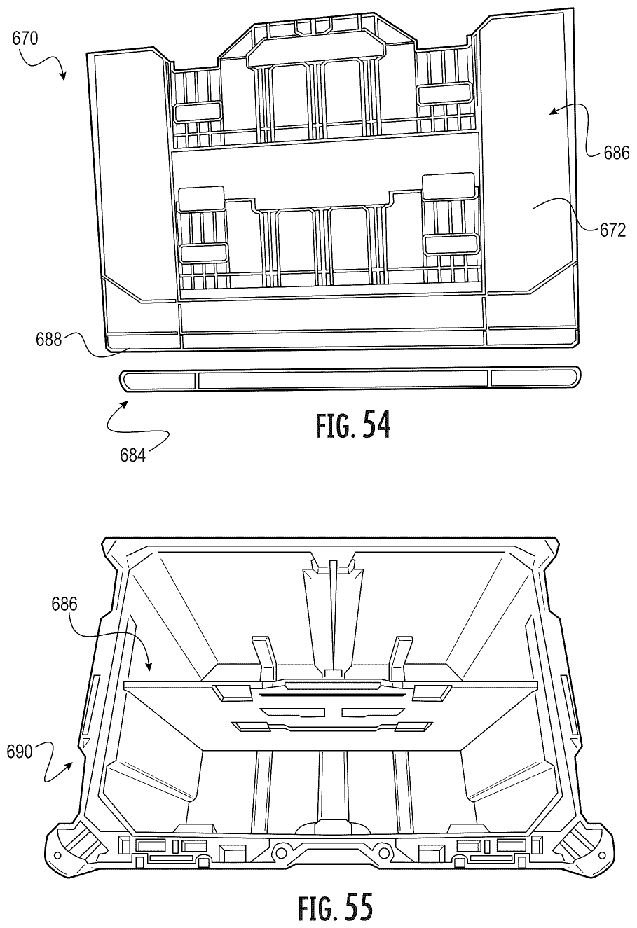

Referring to FIGS. 54-55, details of a modification of divider 670 are shown according to an exemplary embodiment. Divider 670 includes a bottom portion 684 and modified divider 686 that includes the remaining portion of original divider 670. In such an embodiment, bottom portion 684 has been removed from a lower edge 688 of divider 670. In various specific embodiments, divider 670 is altered by trimming along lower edge 688. As a result of the modification, a divider 686 is produced. In a specific embodiment, divider 686 has a dimension that is less than the same dimension on divider 670. In a specific embodiment, divider 686 has a height (defined in the orientation shown in FIG. 54) that is less than a height of divider 670. As shown in FIG. 55, after the alteration of divider 670, new divider 686 is sized to couple to utility module 690. In various embodiments, utility module 690 is a storage container, shown as a tool box.

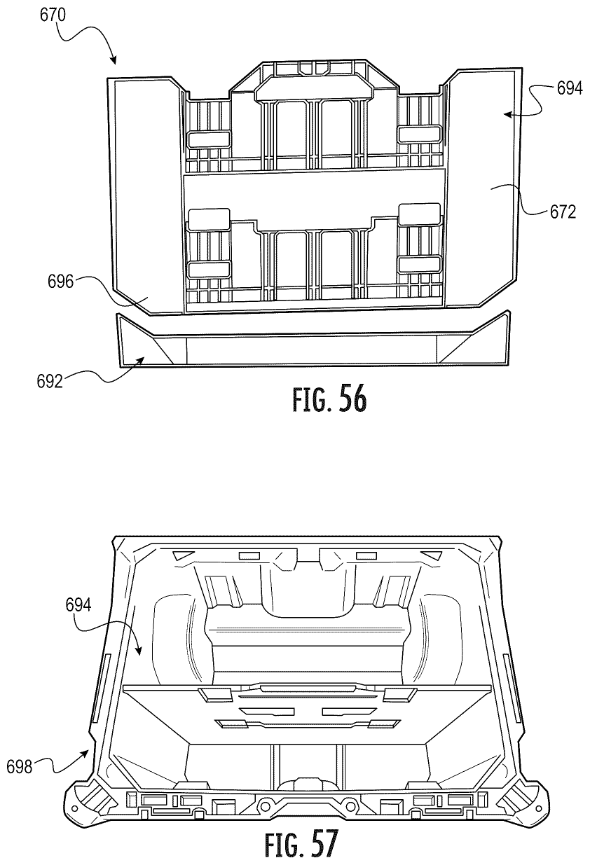

Referring to FIGS. 56-57, details of a modification of divider 670 are shown according to another exemplary embodiment. Divider 670 includes a bottom section 692 and modified divider 694 that includes the remaining portion of original divider 670. In such an embodiment, bottom section 692 has been removed from an edge 696 of divider 670. Edge 696 has a different position than lower edge 688.

In various specific embodiments, divider 670 is altered by trimming along edge 696. As a result of the modification, a divider 694 is produced. In a specific embodiment, divider 694 has a dimension that is less than the same dimension on divider 670. In a specific embodiment, divider 694 has a height (defined in the orientation shown in FIG. 56) that is less than a height of divider 670. As shown in FIG. 57, after the alteration of divider 670, new divider 694 is sized to couple to utility module 698. In various embodiments, utility module 698 is a storage container, shown as a drawer.

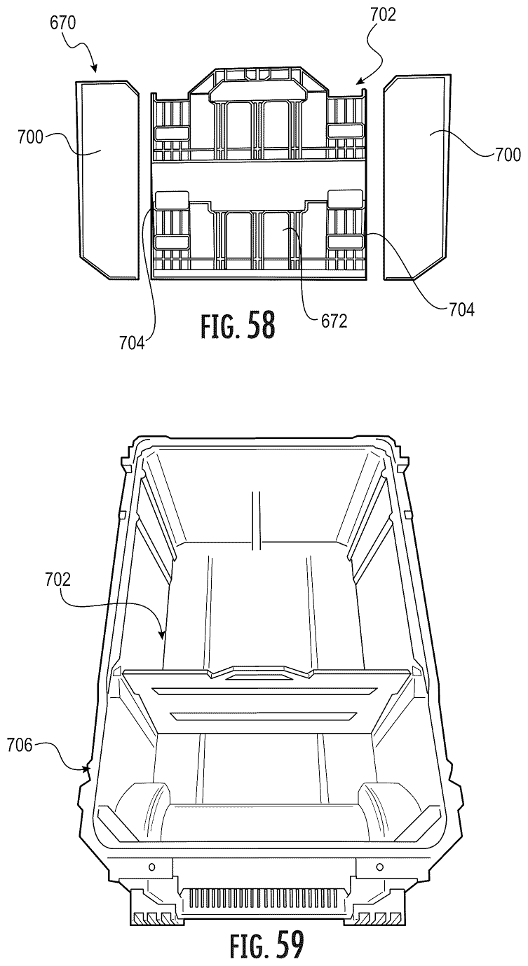

Referring to FIGS. 58-59, details of a modification of divider 670 are shown according to another exemplary embodiment. Divider 670 includes a side sections 700 and modified divider 702 that includes the remaining portion of original divider 670. In such an embodiment, side sections 700 have been removed from opposing edges 704 of divider 670. Edges 704 extend in a different direction than edge 696 and lower edge 688. In various specific embodiments, opposing edge 704 extend in a perpendicular orientation to edge 696 and lower edge 688.

In various specific embodiments, divider 670 is altered by trimming along opposing edges 704. As a result of the modification, a divider 702 is produced. In a specific embodiment, divider 702 has a dimension that is less than the same dimension on divider 670. In a specific embodiment, divider 702 has a width (defined in the orientation shown in FIG. 58) that is less than a width of divider 670. As shown in FIG. 59, after the alteration of divider 670, new divider 702 is sized to couple to utility module 706. In various embodiments, utility module 706 is a storage container, shown as an extended tool box.

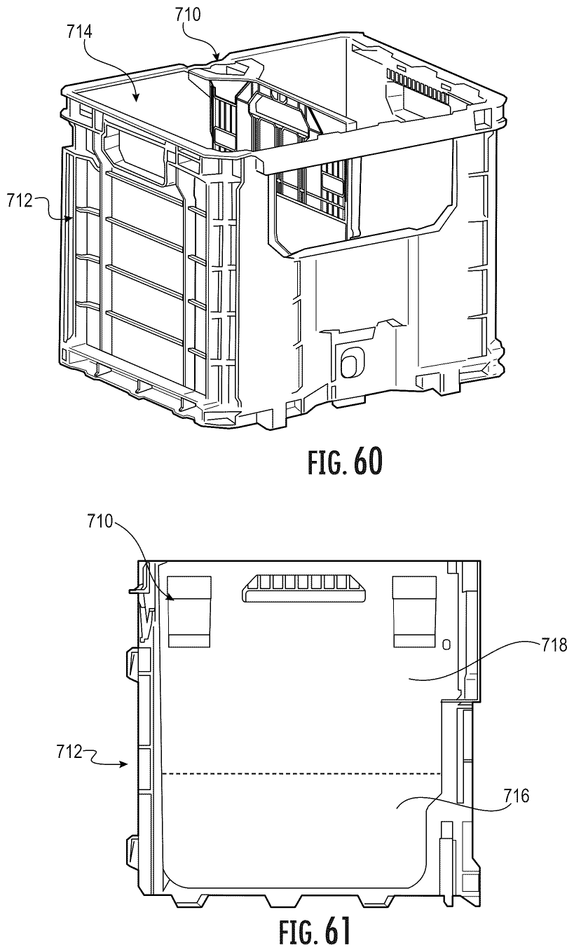

Referring to FIGS. 60-61, details of an internal adapter, shown as a divider 710 that is modifiable are shown according to another exemplary embodiment. Divider 710 is configured to be utilized with a storage device, shown as crate 712. Divider 710 is sized to fit within cavity 714 of crate 712. A bottom, removable portion 716 is shown according to an exemplary embodiment. When removable portion 715 is trimmed or removed from divider 710, the remaining portion, new divider 716 is sized to fit within a storage device with less depth than crate 712.

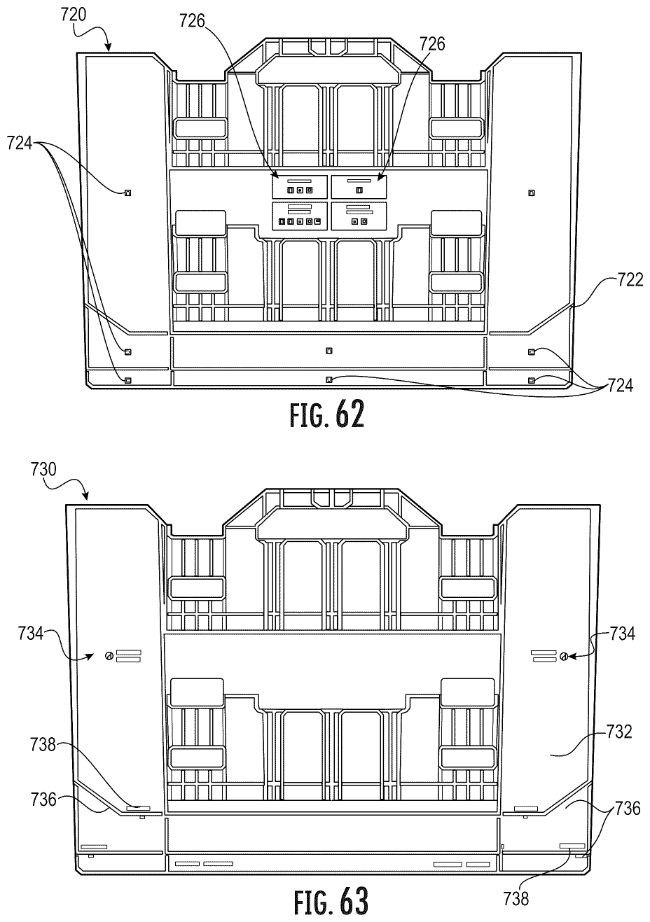

Referring to FIGS. 62-65, details of various internal adapters, shown as dividers are provided. An internal adapter, shown as divider 720 includes a guide for adapting divider 720 to various storage devices. Specifically, divider 720 includes a surface 722 that includes at least one label 724. In various embodiments, divider 720 includes a plurality of labels 724. The modifiable and/or trimmable portions of divider 720 each include a label. Divider 720 further includes a guide 726. Guide 726 includes a reference for various skew numbers of utility modules. Guide 726 includes labels 724 corresponding to the labels located elsewhere on divider 720. In practice, a user can reference guide 726 and determine based on the skew number of the target storage device, which portions of divider 720 are required and which portions of divider 720 should be removed.

Referring to FIG. 63, details of an internal adapter, shown as divider 730 are shown according to another exemplary embodiment. Divider 730 includes a surface 732 with skew number labels 734 and cut indicators or lines 736. Each cut line 736 includes a corresponding label 738 positioned adjacent to the cut line 736. In practice, a user can read the skew number labels 734 positioned on surface 732 to determine which portions of divider 730 are required for use with the chosen storage device. Then, the user can trim or remove portions of divider 730 by using the cut lines 736 that have corresponding labels 738 that include the skew numbers.

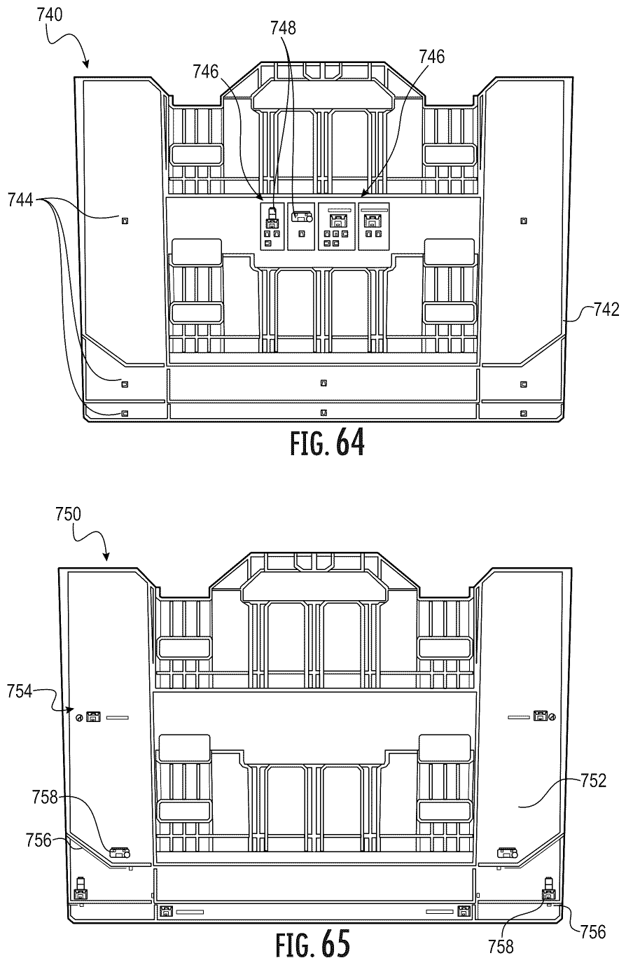

Referring to FIG. 64, details of an internal adapter, shown as divider 740 are shown according to another exemplary embodiment. Divider 740 includes a surface 742 with labels 744. Divider 740 further includes a guide 746. Guide 746 includes a reference with images or icons 748 of various utility modules. Guide 726 also includes labels 744 corresponding to the labels located elsewhere on divider 740 positioned in a group with the reference images 748. In practice, a user can reference guide 746 and determine based on the icon 748 of the target storage device, which portions of divider 740 are required and which portions of divider 740 should be removed.

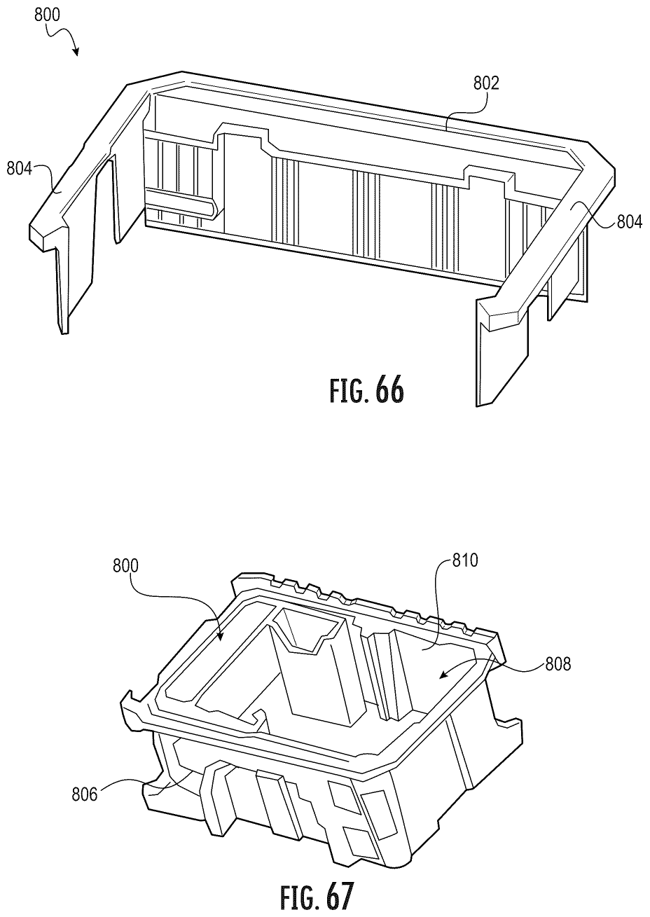

Referring to FIG. 65, details of an internal adapter, shown as divider 750 are shown according to another exemplary embodiment. Divider 750 includes a surface 752 with skew icon labels 754 and cut indicators or lines 756. Each cut line 756 includes a corresponding icon label 758 positioned adjacent to the cut line 756. In practice, a user can see the skew icon or image labels 758 positioned on surface 752 to determine which portions of divider 750 are required for use with the chosen storage device. Then, the user can trim or remove portions of divider 750 by using the cut lines 756.

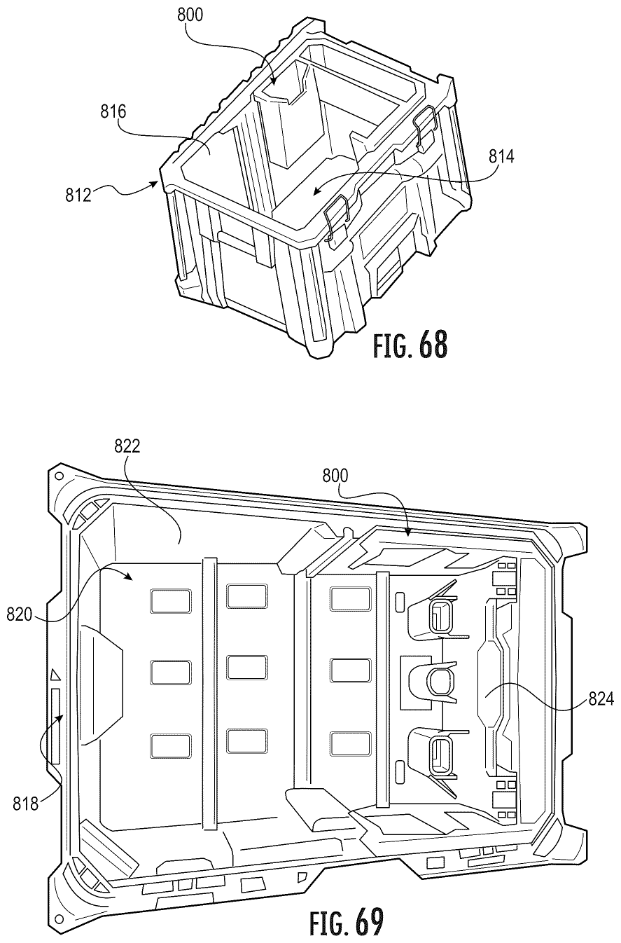

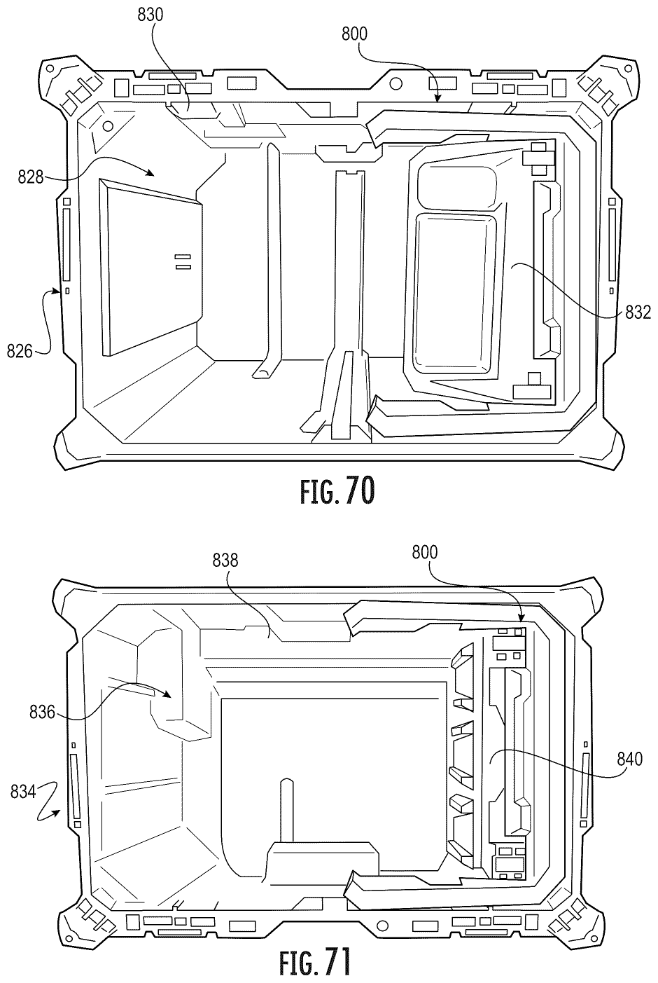

Referring to FIGS. 66-71, details of an internal adapter, shown as perimeter adapter 800 are shown according to an exemplary embodiment. Perimeter adapter 800 is intended to be coupled along or at least partially against an internal wall of a storage device. Perimeter adapter 800 includes a body 802 that extends and opposing arms 804 that extend outward from opposing ends of body 802. Perimeter divider 800 is couplable to a utility module 806 and specifically within cavity 808 along an inner surface 810 that defines cavity 808. Perimeter adapter 800 is configured to support a variety of accessory rails 824, 834, 840 within various utility modules 820, 826, 834.

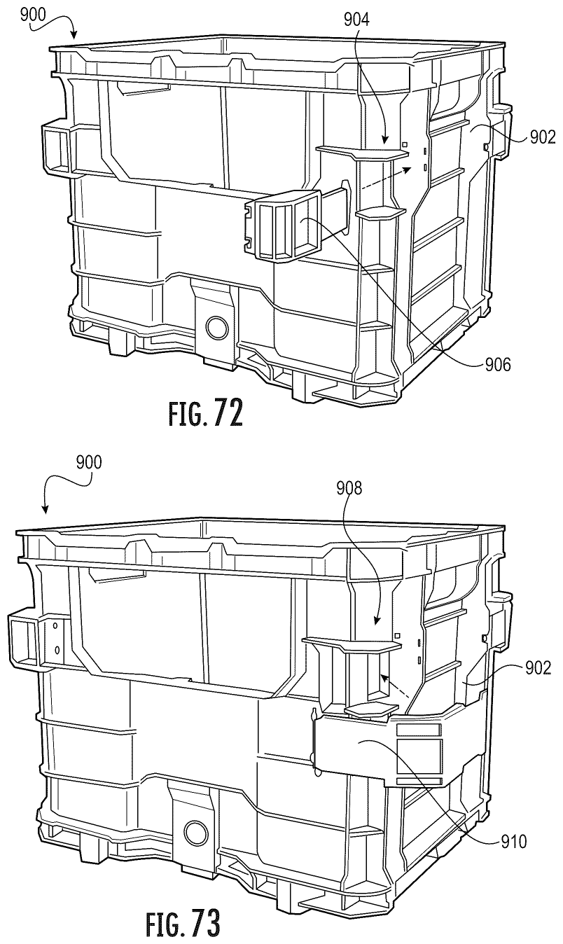

Referring to FIGS. 72-73 details of an external attachment structure for a storage device are shown according to an exemplary embodiment. Storage device or crate 900 includes an exterior surface 902 with an attachment structure 904. An adapter 906 is configured to be slidably attached to structure 904. In another embodiment, crate 900 includes attachment structure 908 that is configured to couple to and support an adapter 910. In various embodiments, adapters 906, 910 are removable from crate 900. In various specific embodiments, once adapters 906, 910 have been coupled to crate 900 the adapters 906, 910 are not removable.

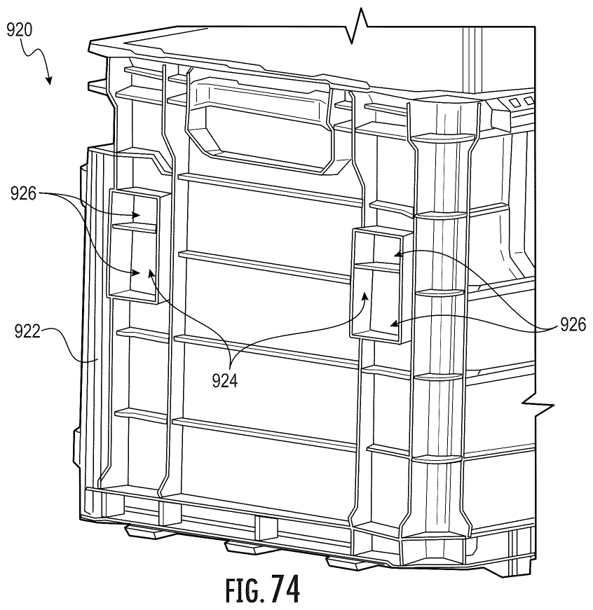

Referring to FIG. 74, details of an external attachment structure of a storage device shown as crate 920, are shown according to another exemplary embodiment. Crate 920 includes an exterior surface 922 with an attachment structure 924. Each attachment structure 924 includes a pair of cutouts or recessed sections 926. In various embodiments, each crate 920 includes a pair of attachment structures 924 along a single side of exterior surface 922. The cutout or recessed sections 926 are compatible with accessory rail clips in a similar manner to the cutout pairs of internal adapters previously discussed.

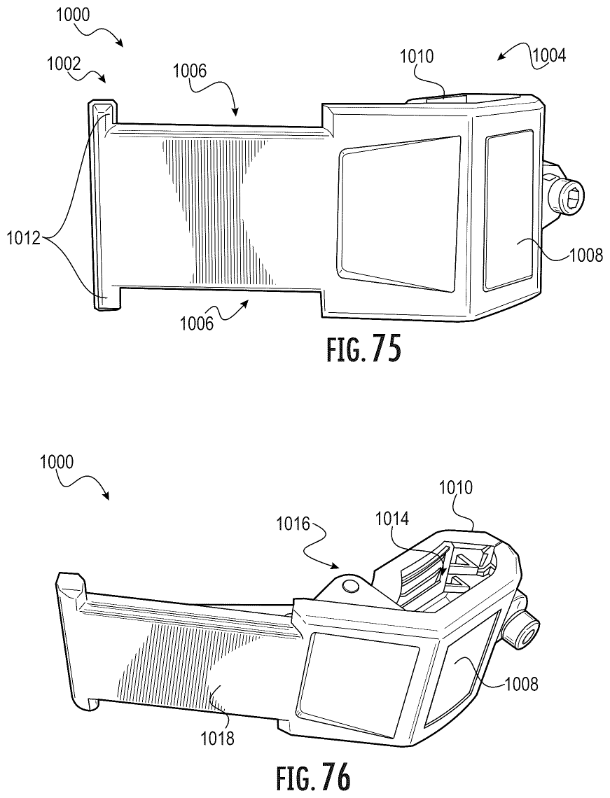

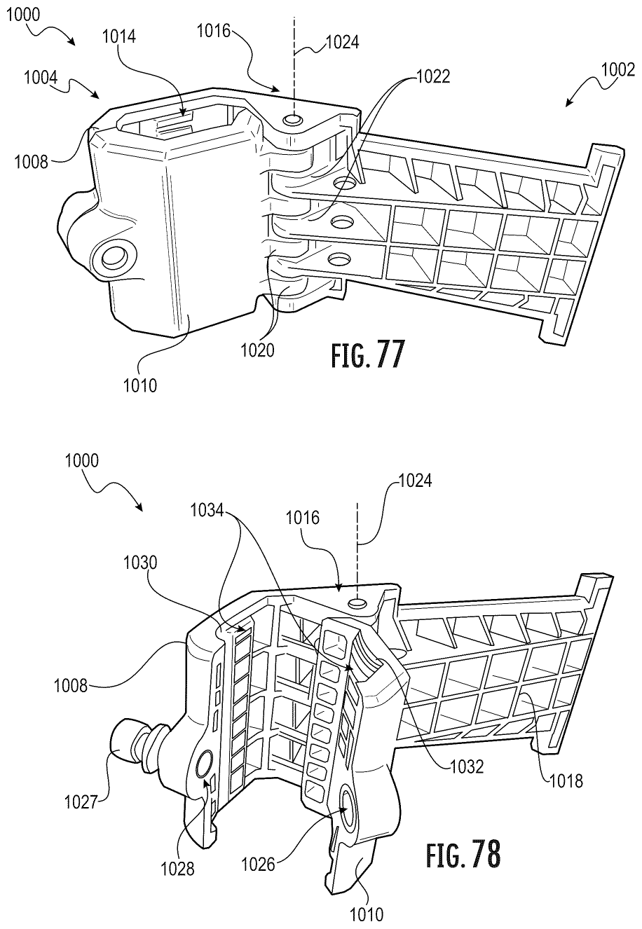

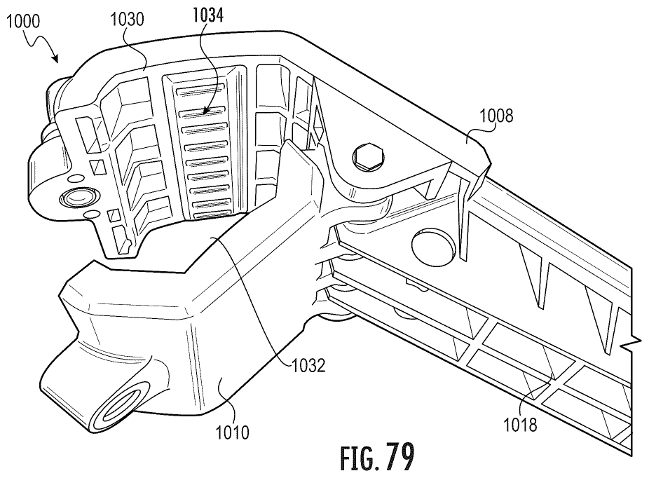

Referring to FIGS. 75-79, details of an adapter 1000 are shown according to another exemplary embodiment. Adapter 1000 is substantially the same as adapters 50 except for the differences discussed herein.

Each adapter 1000 includes a clamping end 1004 configured to extend around and grasp or hold the corner posts 22, 38, 48 and an opposing engagement end 1002. The engagement ends 1002 are configured to support or couple to a storage device. The engagement end 56 includes a recessed section 1006. Recessed section 1006 extends inward in the direction of the minor dimension or transverse direction of adapter 1000. In other words, recessed section 1006 extends inward from the outer edge of the longitudinally extending body 1018. In a specific embodiment, adapter 1000 includes a pair of recessed sections 1006 (i.e., an upper recessed section 1006 and a lower recessed section 1006). In various embodiments, the longitudinally extending body 1018 has a first width defined in the direction transverse to the longitudinal axis (i.e., between outer edges). In such embodiments, the recessed sections 1006 have a second width that is less than the first width. In various embodiments, tabs 1012 of adapter 1000 have a third width that is the same as the first width. In various embodiments, the tabs 1012 may have a third width that is different than the first width or the second width.

Each adapter 1000 includes a first piece, shown as front piece 1008 and second piece, shown as a rear clamp 1010 rotatably coupled to front piece 1008. A corner post bore 1014 is defined between front piece 1008 and rear clamp 1010. When adapter 1000 is coupled to the utility module 10, 30, 40, the corner post 22, 38, 48 is positioned within corner post bore 1014.

Front piece 1008 includes a longitudinally extending body 1018 extending along a longitudinal axis of the adapter 1000 with one or more tabs 1012 positioned at the engagement end 1002 of body 1018 that opposes the clamping end 1004. Tab 1012 is positioned at a distal end of recessed section 1006. Front piece 70 further includes a plurality of rearward extending (i.e., toward rear clamp 1010) projections 1008. Rear clamp 1010 includes frontward extending (i.e., toward front piece 1008) projections 1020. Rearward extending projections 1020 and frontward extending projections 1022 together form a hinge 1016 of adapter 1000. Hinge 1016 allows rear clamp 1010 to move about an axis of rotation 1024.

Front piece 1008 further includes an inward facing surface 1030 that interfaces against the corner post 22, 38, 48 when adapter 1000 is coupled to the utility module 10, 30, 40. Similarly, rear clamp 1010 includes an inward facing surface 1032 that interfaces against the corner post 22, 38, 48 when adapter 1000 is coupled to the utility module 10, 30, 40, etc. Inward facing surface 1030 of front piece 1008 and inward facing surface 1032 of rear clamp 1010 together define the corner post bore 1014. Front piece 1008 includes a bore 1028 that extends in a generally perpendicular (i.e., 90 degrees plus or minus 10 degrees) orientation to corner post bore 1014. Rear clamp 1010 includes a bore 1026 that extends in a generally perpendicular (i.e., 90 degrees plus or minus 10 degrees) orientation to corner post bore 1014. When adapter 1000 is in a closed position, bore 1028 of front piece 1008 aligns with bore 1026 of rear clamp 1010. A user can couple front piece 1008 to rear clamp 1010 using a fastener, shown as bolt 1027. In various specific embodiments, inward facing surface 1030, 1032 include a grip 1034 configured to resists movement of adapter 1000 relative to the corner post 22. In other words, grips 1034 are formed from a material configured to engage surfaces of corner posts 22.

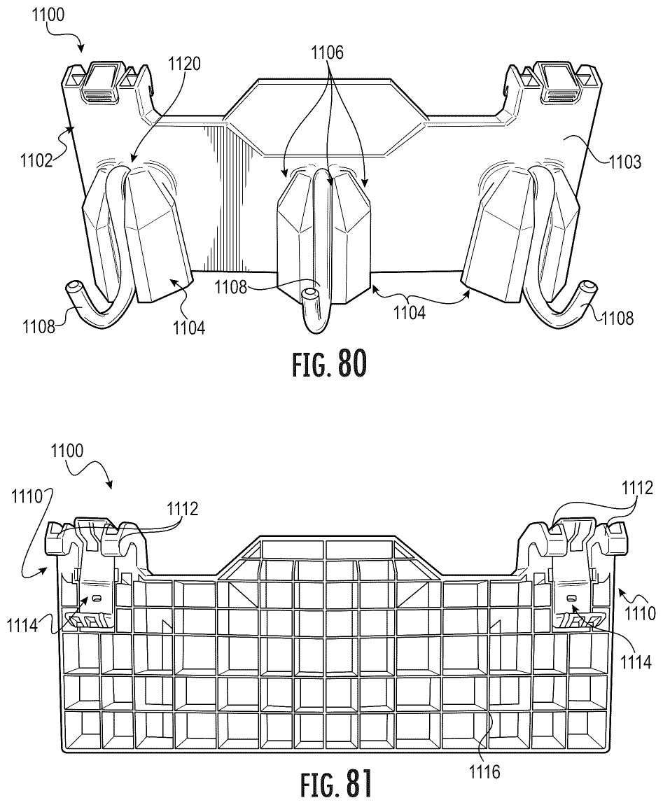

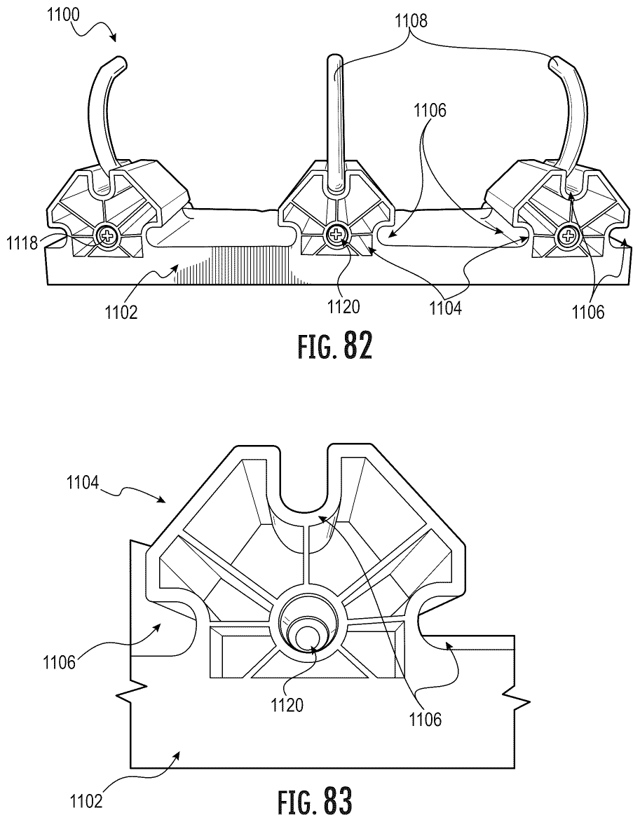

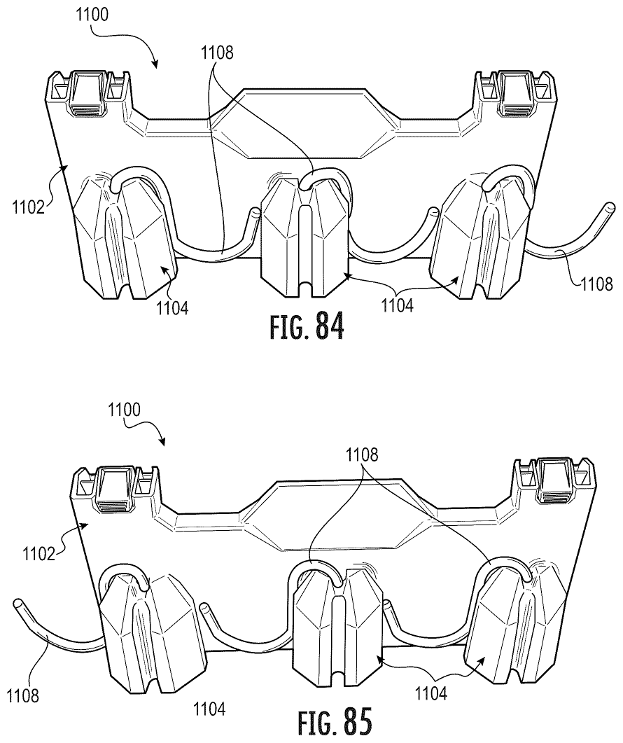

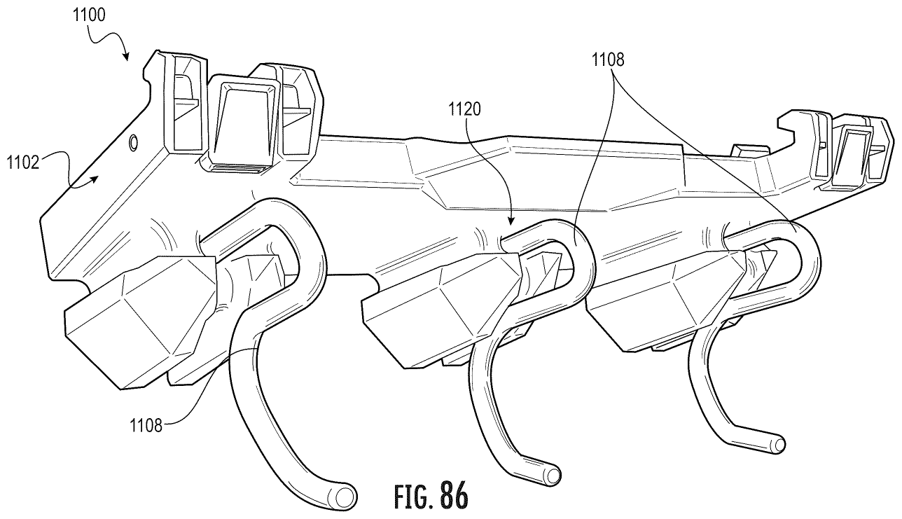

Referring to FIGS. 80-86, details of an accessory rail 1100 are shown according to another exemplary embodiment. Accessory rail 1100 includes a body 1102 with a surface, shown as a front surface 1103 and an opposing surface, shown as back surface 1116. One or more support structures 1104 extend outward from front surface 1103. In specific embodiments, accessory rail 1100 includes three support structures 1104. In other embodiments, accessory rail 1100 includes a different number of support structures 1104 (e.g., 1, 2, 4, etc.). Each support structure 1104 is configured to support an attachment structure shown as a hook 1108. Each support structure 1104 includes a plurality of channels 1106 in which hook 1108 can be positioned.

In specific embodiments, each support structure 1104 includes three channels 1106. Three channels 1106 allow for hook 1108 to be oriented in three separate positions. In a first orientation, hook 1108 is received in a front or middle channel 1106 and extends with the hook end facing away from rail body 1102. Additionally, hook 1108 can be positioned in a right channel 1106 in a second orientation. The second orientation is a storage position to reduce the dimensions of rail 1110 and prevent hook 1108 from engaging other tools, accessories, people, etc. when not in use. Hook 1104 can similarly be positioned within the left channel 1106 in a third orientation.

Each support structure 1104 includes a bore 1120 extending through support structure 1104. Hook 1108 includes an end or stop 1118 that prevents hook 1108 from being pulled out of bore 1120 as the orientation of hook 1108 is changed. Rail 1100 further includes engagement ends 1110. Each engagement end 1110 includes at least one clip 1112 and a spring loaded clip 1112 configured to securely couple to adapter 1000 and/or the utility modules (e.g., 10, 30, 40). As will be generally understood, spring loaded clip 1114 includes a spring such that spring loaded clip 1114 can be moved and/or pulled away from body 1102 in an extended position and once released, spring loaded clip 1114 will move back toward body 1102 to allow for secure engagement with adapter 1000 and/or the utility modules.

In various embodiments, the spring loaded clip 1114 has an orientation that is opposite of the clip(s) 1112 such that spring loaded clip 1114 faces clip 1112. In other words, in various embodiments, where clip 1112 includes a protrusion that extends downward, spring loaded clip 1114 has a protrusion that extends in an opposite or upward (see e.g., orientation shown in FIG. 81). As will be generally understood clip(s) 1112 and spring clip(s) 1114 include a space positioned between their respective protrusions.

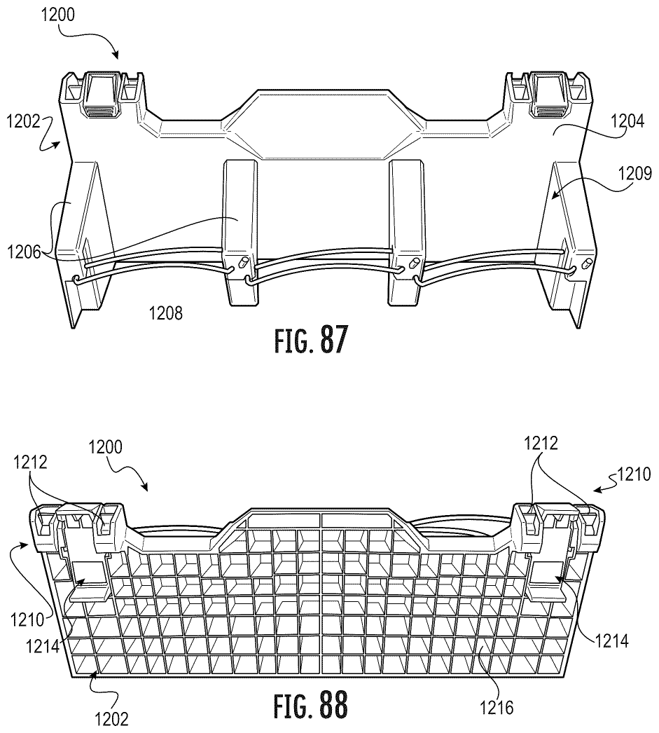

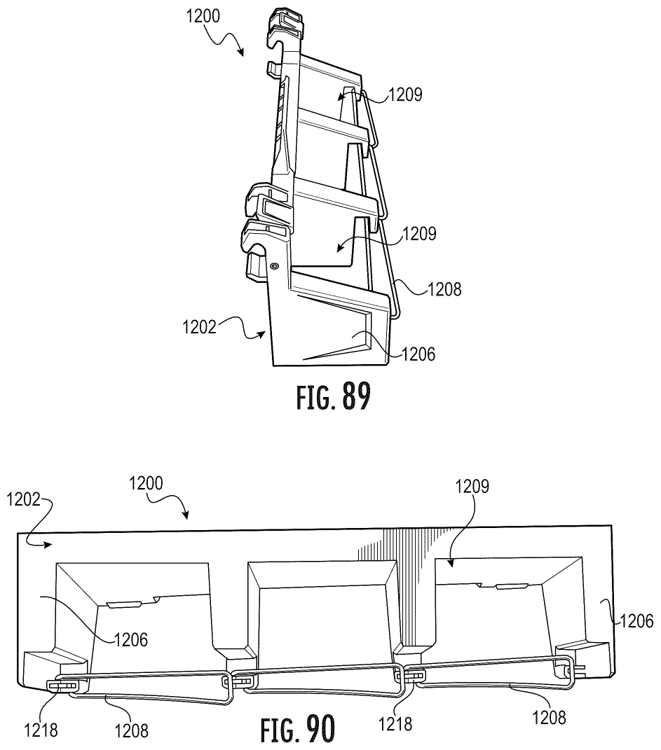

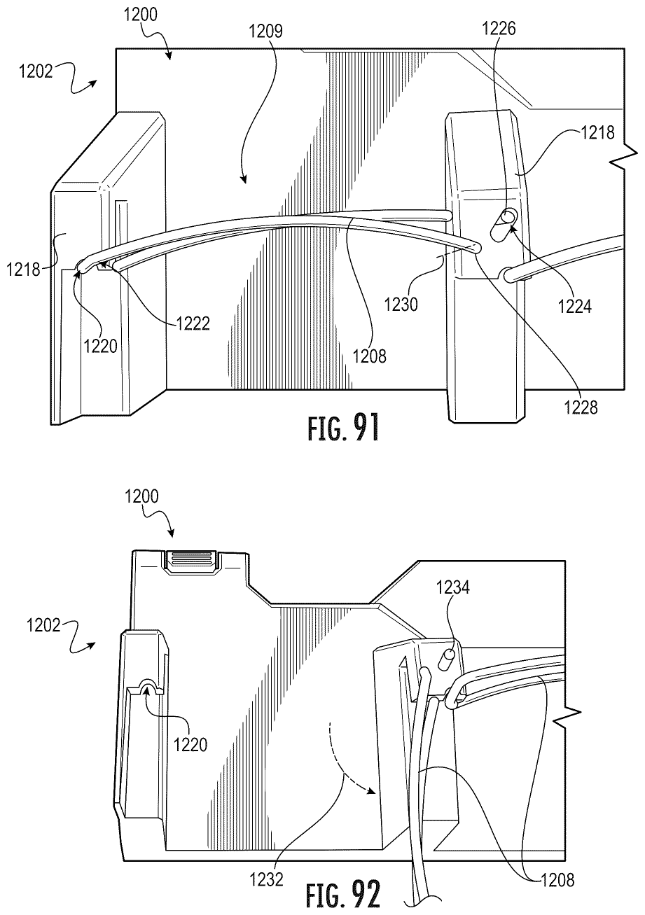

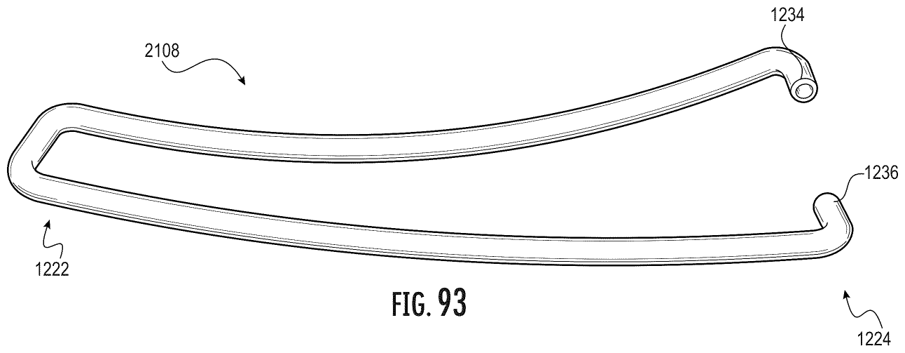

Referring to FIGS. 87-93, details of an accessory rail 1200 are shown according to another exemplary embodiment. Accessory rail 1200 includes a rail body 1202 with a surface, shown as front surface 1204. Side walls 1206 extend outward, away from front surface 1204. One or more gates 1208 extend longitudinally between side walls 1206 to define storage compartments 1209. In general, for storage devices with doors, the doors or gates are swung open by moving outward or away from the front surface. In contrast, gates 1208 are configured to swing downward or toward a bottom edge of rail body 1202. Applicant believes this improves case and efficiency of opening gates 1208. In contrast to conventional storage doors, gates 1208 do not allow for easy remove of tall or long tools and/or accessories storage along the sides of utility module systems because the tool must be removed from the bottom or top. Applicant believes case of removal of tools such as square levels, conduit bends, etc. is improved.

In various embodiments, gate 1208 is a resilient structure. In various specific embodiments, gate 1208 is a spring. As will be generally understood, gate(s) 1208 restrain or secure tools and/or accessories against accessory rail 1200 and/or a utility module, modular system, etc. When gate 1208 is a spring, the gate 1208 resists movement away from rail body 1202.

Side walls 1206 include a barrier section 1218 with a notch 1220 configured to receive a closed end 1222 of gate 1208. An open end 1224 of gate 1208 opposed closed end 1222. At least part of open end 1224 of gate 1208 is received within a slot, shown as elongate slot 1226. The other portion of open end 1224 is received within a bore 1228 to secure gate 1208 to side wall. As shown in FIG. 92, gate 1208 is pivotable in a downward direction, away from barrier 1218 and/or side wall 1206. Elongate slot 1226 allows for movement to 90 degrees of gate 1208.

Rail 1200 further includes engagement ends 1210. Each engagement end 1210 includes at least one clip 1212 and a spring loaded clip 1212 configured to securely couple to adapter 1000 and/or the utility modules (e.g., 10, 30, 40). As will be generally understood, spring loaded clip 1214 includes a spring such that spring loaded clip 1214 can be moved and/or pulled away from body 1202 in an extended position and once released, spring loaded clip 1214 will move back toward body 1202 to allow for secure engagement with adapter 1000 and/or the utility modules.

In various embodiments, the spring loaded clip 1214 has an orientation that is opposite of the clip(s) 1212 such that spring loaded clip 1214 faces clip 1212. In other words, in various embodiments, where clip 1212 includes a protrusion that extends downward, spring loaded clip 1214 has a protrusion that extends in an opposite or upward (see e.g., orientation shown in FIG. 88). As will be generally understood clip(s) 1212 and spring clip(s) 1214 include a space positioned between their respective protrusions.

In various embodiments, rail 1200 includes a first engagement end 1210 and a second engagement end 1210 with a longitudinally extending rail body 1202 between and connecting the first engagement end 1210 and second engagement end 1210. A first wall shown as sidewall 1206 extends outward from longitudinally extending rail body 1202 and a second wall shown as sidewall 1206 extends outward from longitudinally extending rail body 1202. A storage compartment 1209 is defined between first sidewall 1206, second sidewall 1206 and gate 1208. In such an embodiment, gate 1208 is pivotable downward from a bottom surface of the first sidewall 1206 or second sidewall 1206.

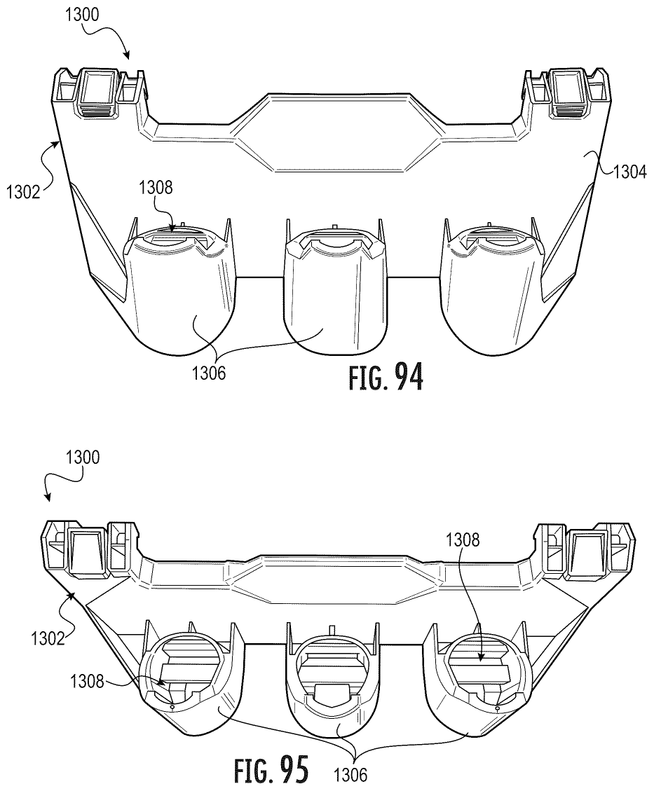

Referring to FIGS. 94-97, details of an accessory rail 1300 are shown according to another exemplary embodiment. Accessory rail 1300 includes a body 1302 with a surface, shown as a front surface 1304 and an opposing surface, shown as back surface 1316. One or more storage structures 1306 extend outward from front surface 1304. In specific embodiments, accessory rail 1300 includes three storage structure 1306. In other embodiments, accessory rail 1300 includes a different number of storage structures 1306 (e.g., 1, 2, 4, etc.). Each storage structure 1306 includes a cavity 1308. In specific embodiments, cavity 1308 is sized to receive and support an energy storage device, such as a battery. In specific embodiments, accessory rail 1300 and specifically cavity 1308 is sized to support 12V batteries or battery packs, such as 12V Lithium Ion batteries. In various embodiments, a bottom opening 1318 is connected to cavity 1308. Bottom opening 1318 allows for charging of energy storage devices while positioned in accessory rail 1300 and/or while coupled to a utility module.

Rail 1300 further includes engagement ends 1310. Each engagement end 1310 includes at least one clip 1312 and a spring loaded clip 1312 configured to securely couple to adapter 1000 and/or the utility modules (e.g., 10, 30, 40). As will be generally understood, spring loaded clip 1314 includes a spring such that spring loaded clip 1314 can be moved and/or pulled away from body 1302 in an extended position and once released, spring loaded clip 1314 will move back toward body 1302 to allow for secure engagement with adapter 1000 and/or the utility modules.

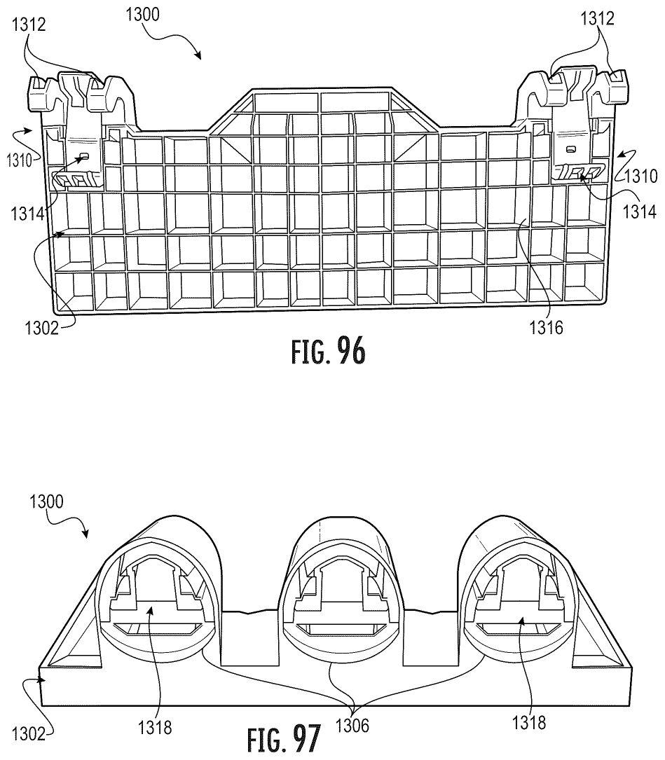

In various embodiments, the spring loaded clip 1314 has an orientation that is opposite of the clip(s) 1312 such that spring loaded clip 1314 faces clip 1312. In other words, in various embodiments, where clip 1312 includes a protrusion that extends downward, spring loaded clip 1314 has a protrusion that extends in an opposite or upward (see e.g., orientation shown in FIG. 96). As will be generally understood clip(s) 1312 and spring clip(s) 1314 include a space positioned between their respective protrusions.

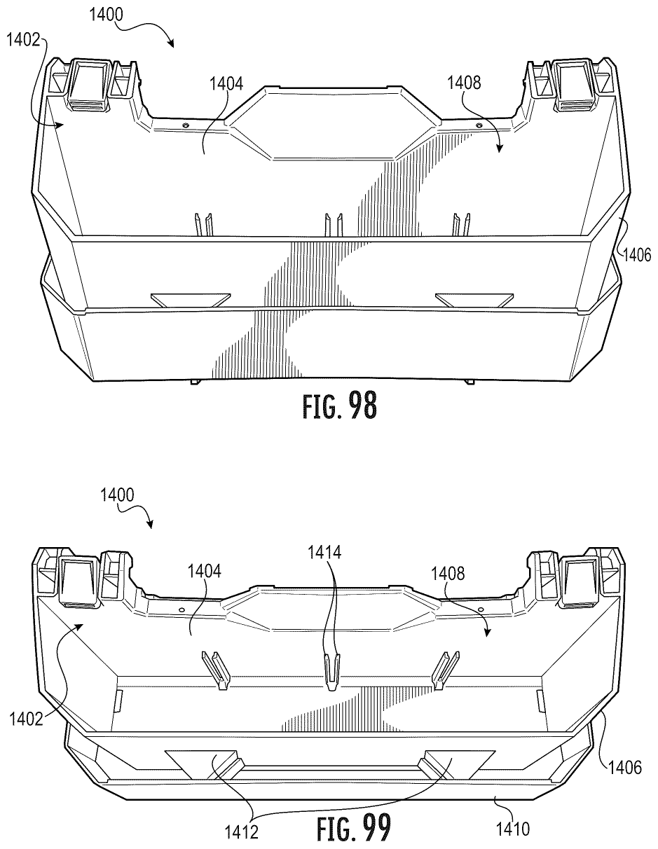

Referring to FIGS. 98-103, details of an accessory rail 1400 are shown according to another exemplary embodiment. Accessory rail 1400 includes a body 1402 with a surface, shown as a front surface 1404 and an opposing surface, shown as back surface 1426. A storage structure 1406 extends outward from front surface 1404. Storage structure 1406 includes a cavity 1408 defined by an inner surface of structure 1406.

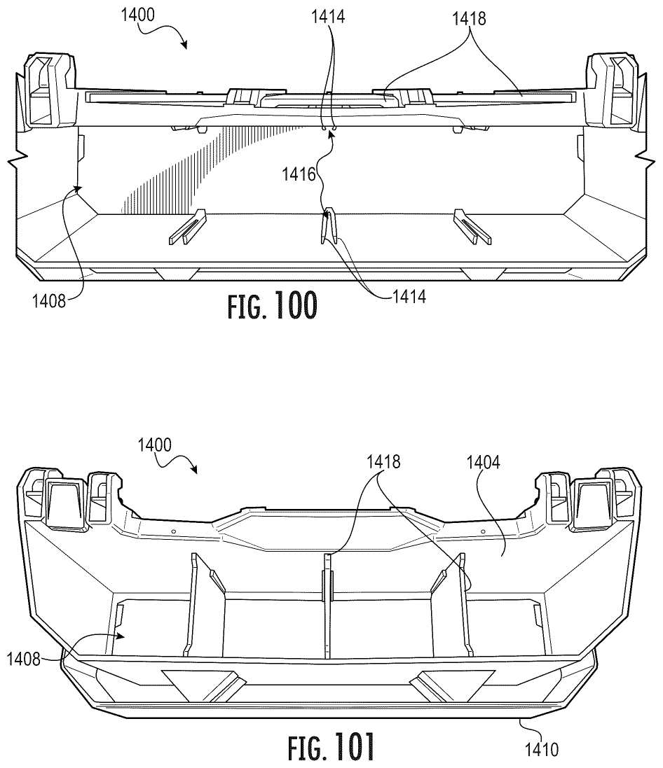

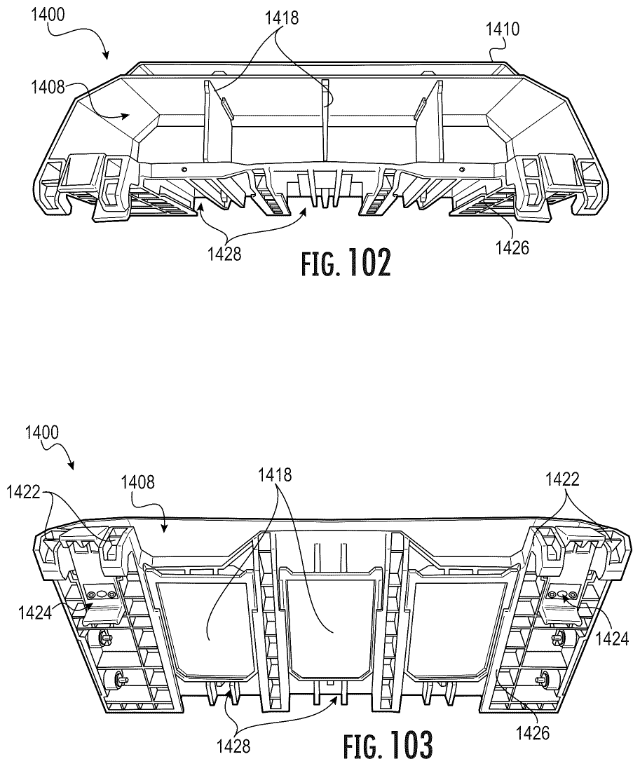

In specific embodiments, accessory rail 1400 includes a front rail 1410 connected to an outward facing surface of storage structure 1406 by one or more protrusions 1412. Protrusions 1412 provide separation for tools and/or accessories that a user may hang along front rail 1410 so there is not unwanted sliding or movement of such accessories. Accessory rail 1400 further includes one or more dividers 1418 configured to separate cavity 1408 into separate compartments. When dividers 1418 are in a first, storage position, the dividers 1418 are received within channels 1428 on back surface 1426 (see e.g., FIG. 103). When in use, dividers 1418 are in a second position in which dividers are positioned within channels 1416 defined between rails 1414 within storage cavity 1408 (see e.g., FIGS. 100, 101).

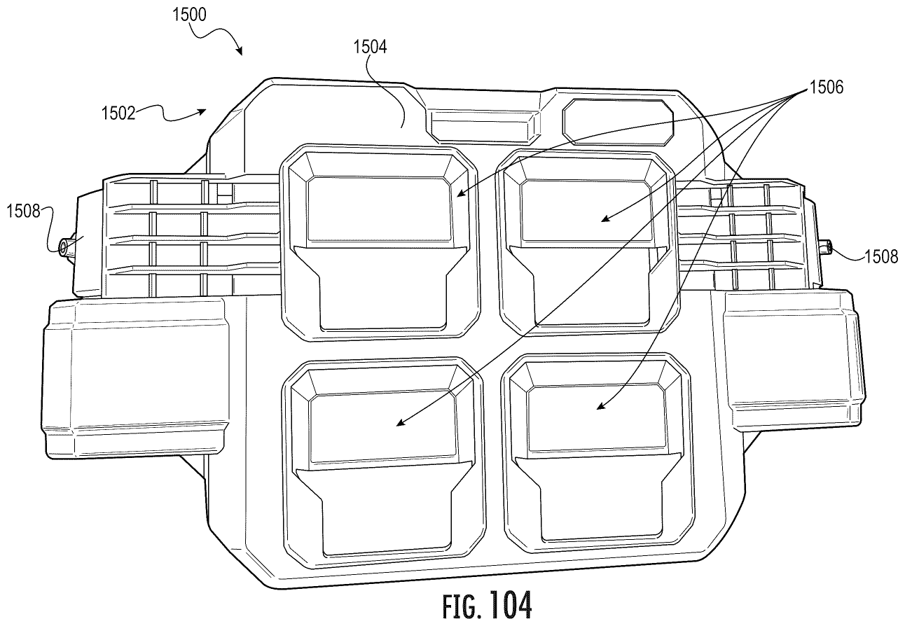

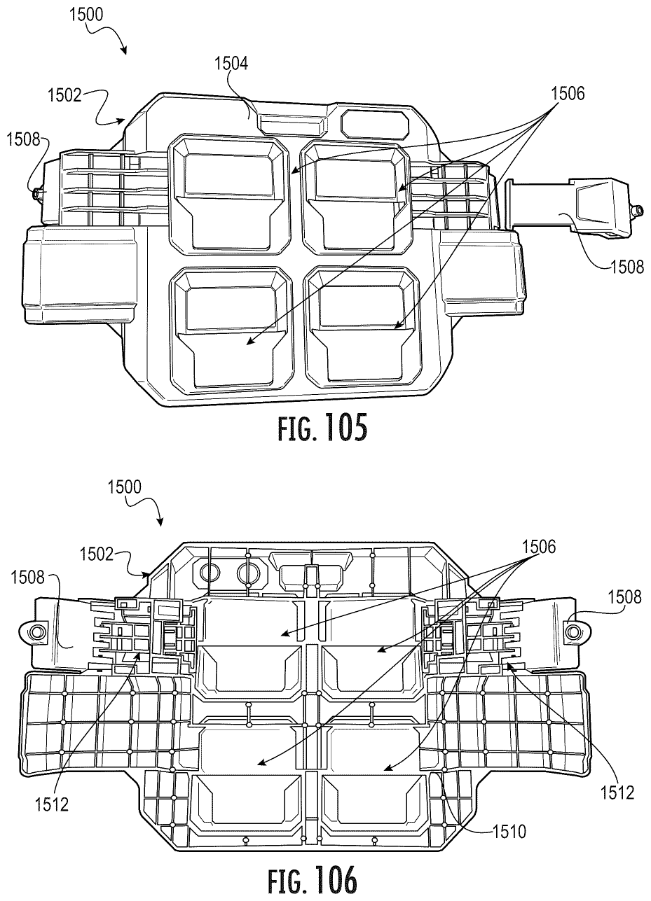

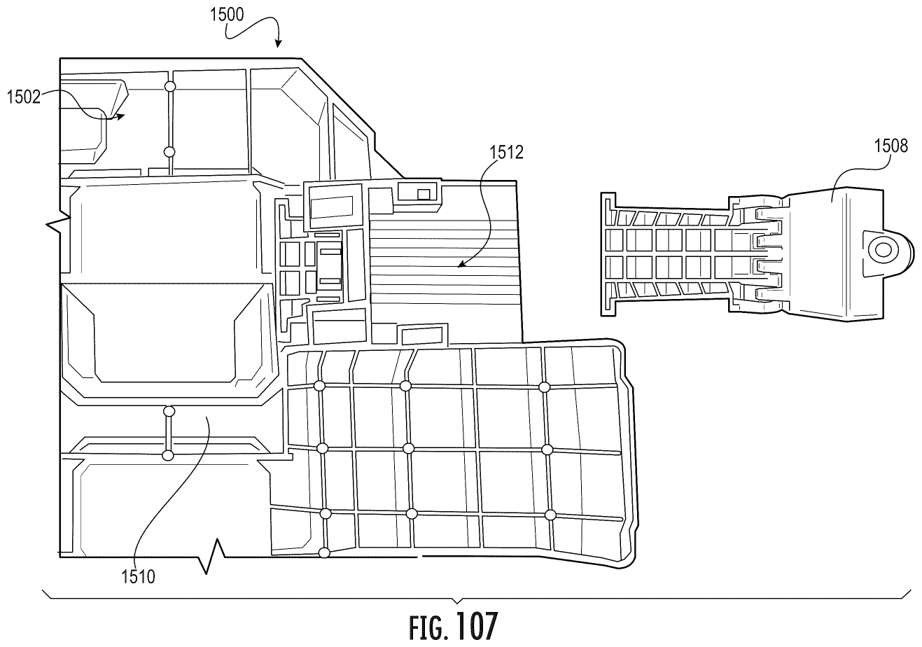

Referring to FIGS. 104-107, details of an accessory rail 1500 are shown according to another exemplary embodiment. Accessory rail 1500 is substantially the same as support rail 248, except for the differences discussed herein. Accessory rail 1500 includes one or more adapters 1508 that are substantially the same as adapters 1000. In various embodiments, adapters 1508 are removably couplable to accessory rail 1500 along rear surface 1510 which includes recessed section(s) configured to receive adapter(s) 1508. In other embodiments, adapters 1508 are permanently coupled to accessory rail 1500 (i.e., not removable).

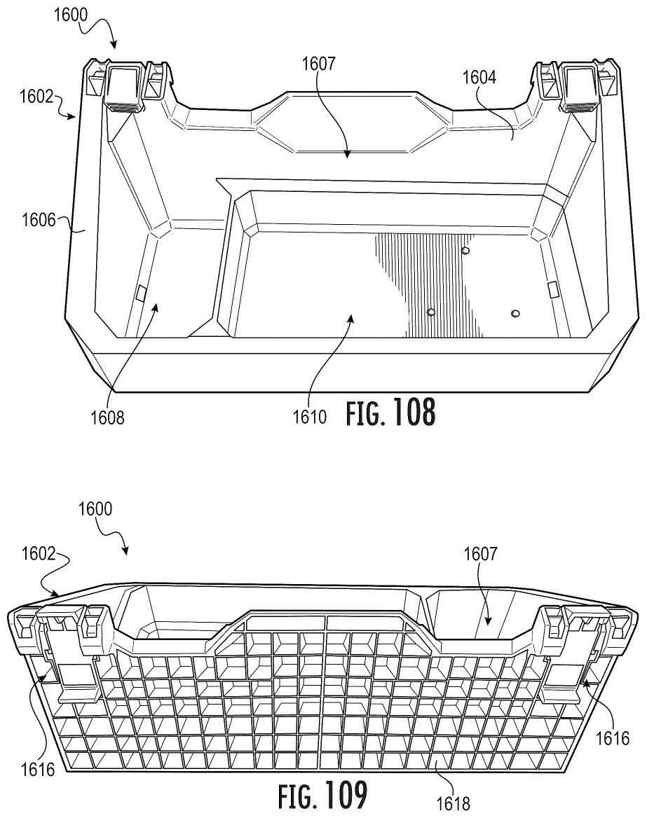

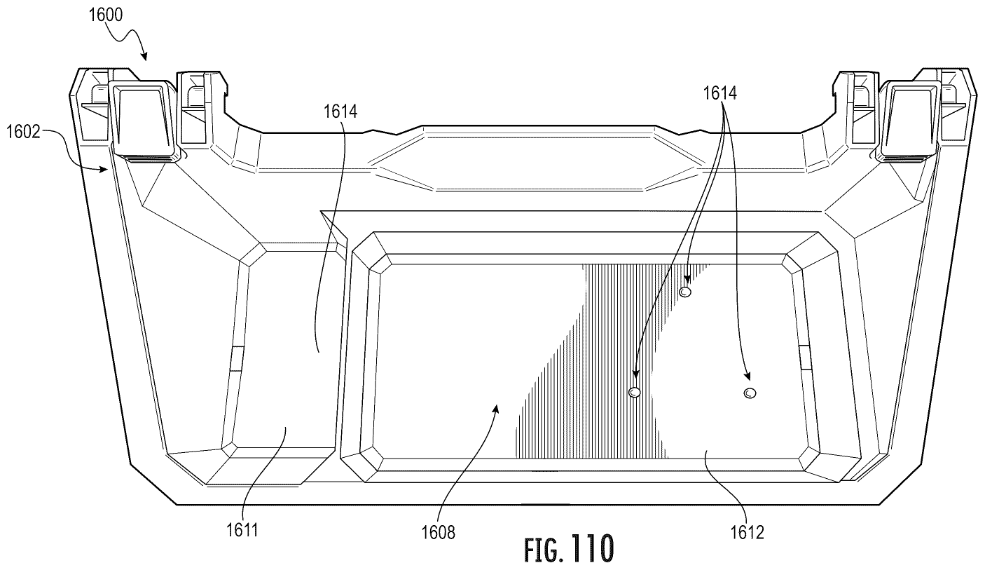

Referring to FIGS. 108-110, details of details of an accessory rail 1600 are shown according to another exemplary embodiment. Accessory rail 1600 includes a body 1602 with a surface, shown as a front surface 1604 and an opposing surface, shown as back surface 1618. A storage structure is defined by a wall 1606 that extends outward from front surface 1604. Storage structure includes a cavity 1607 defined by an inner surface of wall 1606. Cavity 1607 includes a first section 1608 and a second section 1610 separated by an internal wall. A bottom surface 1611 of first section 1608 includes one or more dimples 1614 configured for coupling to other storage devices (e.g., cups, bins, etc.). Similarly, a bottom surface 1612 of second section 1610 includes dimples 1614. Rail 1600 further includes engagement ends 1616. Each engagement end 1616 is substantially the same as engagement ends 96, 1310 previously discussed.

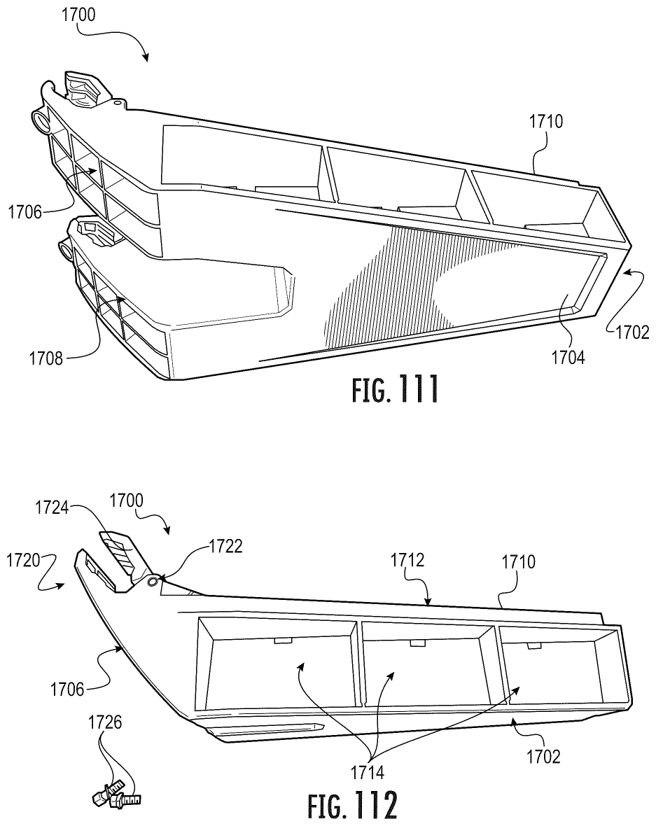

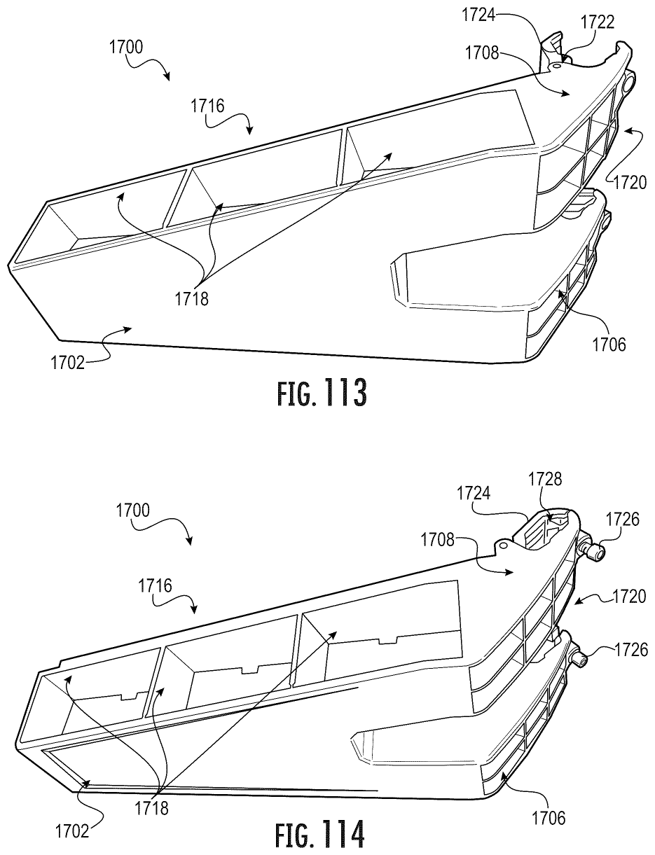

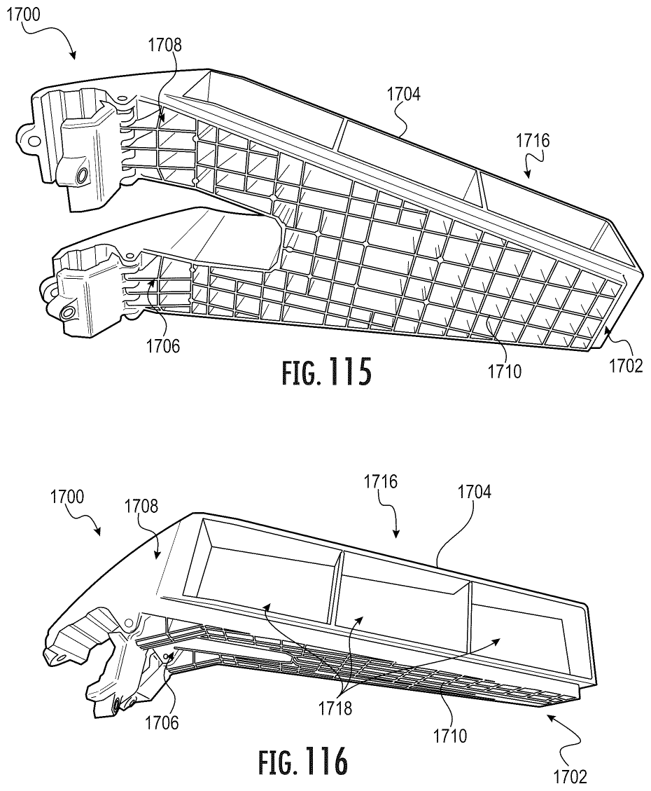

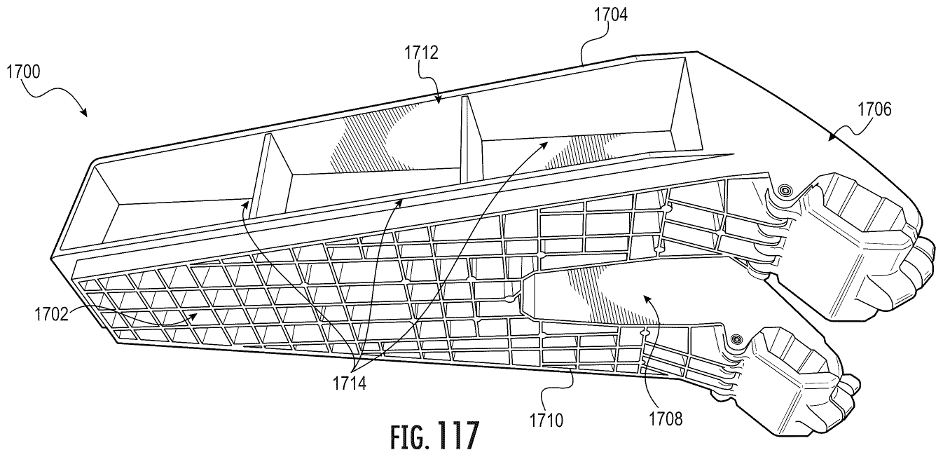

Referring to FIGS. 111-117, details of an accessory rail 1700 are shown according to another exemplary embodiment. As will be discussed in greater detail below, accessory rail 1700 can be utilized with accessory rail 1200.

Accessory rail 1700 includes a body 1702 with a first arm 1706 and a second arm 1708. Rail body 1702 includes a first or front surface 1704 and an opposing second or rear surface 1710. First arm 1706 includes a first section 1712 including a plurality of storage recesses 1714. In various specific embodiments, first arm 1706 includes three recesses 1714 in first section 1712. In other embodiments, first section 1712 includes a different number of recesses 1714 (e.g., 2, 4, 5, etc.). Recesses 1714 provide separate storage spaces for various accessories and/or tools. As previously noted, in particular, an end of tall or long tools and/or accessories storage can be positioned within one or more recesses 1714 while the opposing end of the long tool and/or accessory is secured by rail 1200 and specifically gate 1208.

Similarly, second arm 1708 includes a second section 1716 that includes a plurality of storage recesses 1718. As can be seen, the symmetrical nature of accessory rail 1700 allows for coupling accessory rail 1700 along either side of utility modules because the orientation can be reversed. Accessory rail 1700 includes an adapter end 1720 configured to be clipped on posts 22 of utility modules. Each portion of adapter end 1720 is substantially the same as clamping end 1004 of adapter 1000. Rear clamp 1724 includes frontward extending (i.e., toward front surface 1704) projections. Rail body 1702 includes rearward extending projections that together with frontward extending projections form a hinge 1722 of rail 1700. Hinge 1722 allows rear clamp 1724 to move about an axis of rotation.

Because of the symmetrical nature of rail 1700, first arm 1706 and second arm 1708 each include individual adapter ends 1720. When accessory rail 1700 is connected to a utility module, both adapter ends 1720 can be coupled to a single corner post of the utility module.

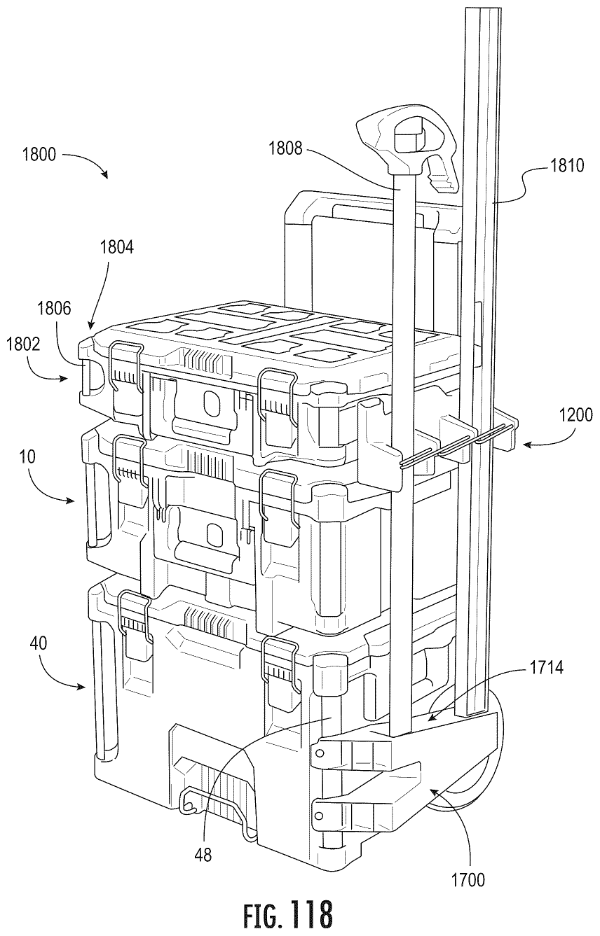

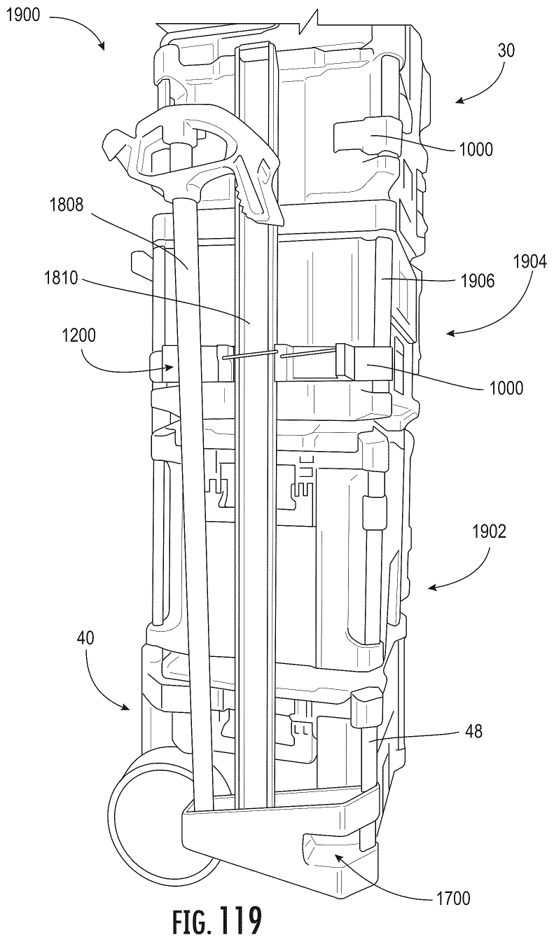

Referring to FIGS. 118-119, details of modular systems 1800 and 1900 are shown according to exemplary embodiments. A modular system 1800 includes a utility module 1802 engaged with utility module 10 and utility module 40. As will be generally understood, modular systems can include various utility modules 10, 30, 40, 1802, etc. stacked in various combinations.

Utility module 1802 is substantially the same as utility modules 10, 30, 40 and includes corners 1804 with posts 1806 extending between upper and lower corners 1804. As shown in FIG. 118, accessory rail 1200 is coupled to and/or supported by posts 1806 of utility module 1802. Additionally, accessory rail 1700 is mounted to utility module 40 such that accessory rail 1700 is positioned below accessory rail 1200 (in the orientation shown in FIG. 118). In this manner, a user can secure long tools such as conduit bender 1808 and a level, shown as box level 1810 to utility modules 1802 and 40. Accessory rail 1700 is coupled to utility modular system 1800 in a first orientation, along a right side of utility modules 1802, 40.

A modular system 1900 is shown according to another exemplary embodiment. Modular system 1900 includes utility modules 1902, 1904 stacked between rolling utility module 40 and utility module 30. Utility modules 1902, 1904 are substantially the same as utility modules 10, 30, 40, 1802 except for the differences discussed herein. Accessory rail 1200 is coupled to and supported by utility module 1904. Specifically, accessory rail 1200 is coupled to posts 1906 while accessory rail 1700 is coupled to posts 48 of utility module 40. Accessory rail 1700 is coupled to utility modular system 1800 in a second orientation, along a left side of utility modules module system 1900.

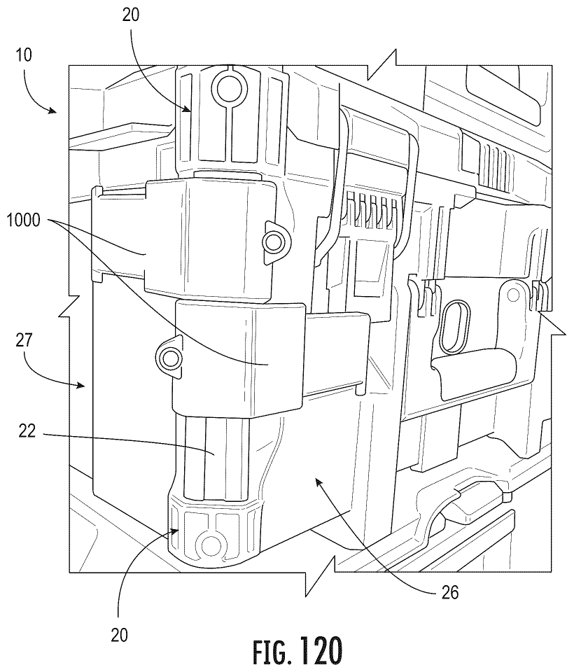

Referring to FIG. 120, details of adapters 1000 coupled to utility module 10 are shown. In contrast to many external mounting systems, adapters 1000 can be coupled in various orientations. A first adapter 1000 is coupled to post 22 such that first adapter 1000 extends along front 26 of utility module 10. Simultaneously, a second adapter 1000 can be coupled to post 22 such that the second adapter 1000 extends in a different direction than first adapter 1000. In the illustrated embodiment, second adapter 1000 extends along side surface 27 of utility module 10. In other words, adapters 1000 allow for coupling accessory rails and/or accessories along adjacent sides of utility module 10 such as the front 26 and side 27.

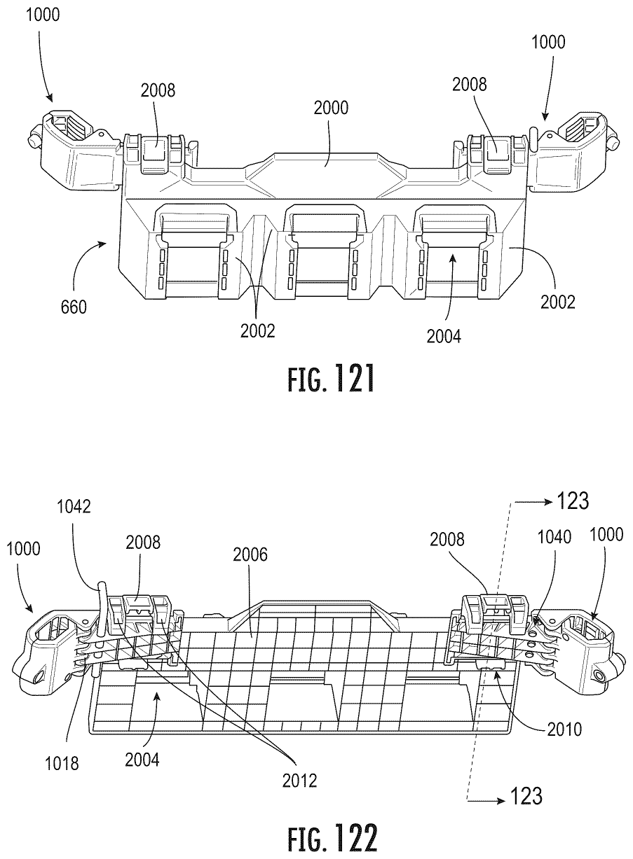

Referring to FIGS. 121-123, details of accessory rail 660 are shown according to an exemplary embodiment. Accessory rail 660 includes a front surface 2000 with one or more holders 2002 extending outward from front surface 2000. Each holder 2002 is configured to receive and secure an accessory to accessory rail 660. An opening 2004 sized to receive an accessory is defined within each holder 2002. Opening 2004 extends through accessory rail 660 from front surface 2000 to a rear surface 2006.

In various specific embodiments, holders 2002 and/or openings 2004 are sized to support 18V batteries or battery packs, such as 18V Lithium Ion batteries. In various specific embodiments, accessory rail 660 includes three holders 2002. In other embodiments, accessory rail 660 includes a different number of holder 2002 (e.g., 2, 4, 5, etc.).

As previously discussed, accessory rails such as accessory rail 660 can be coupled to adapters 1000 to allow for coupling to modular systems (e.g., 1800, 1900) and/or utility modules 10, 30, 40, 1802, 1904, etc. In various embodiments, adapters 1000 include a bore 1040 positioned adjacent to clamping end 1004. Bore 1040 is configured to act as a further storage location and receive a tool such as a hex key 1042 that can be used in tightening, loosening, fasteners while attaching adapters 1000 or accessory rails in modular systems.

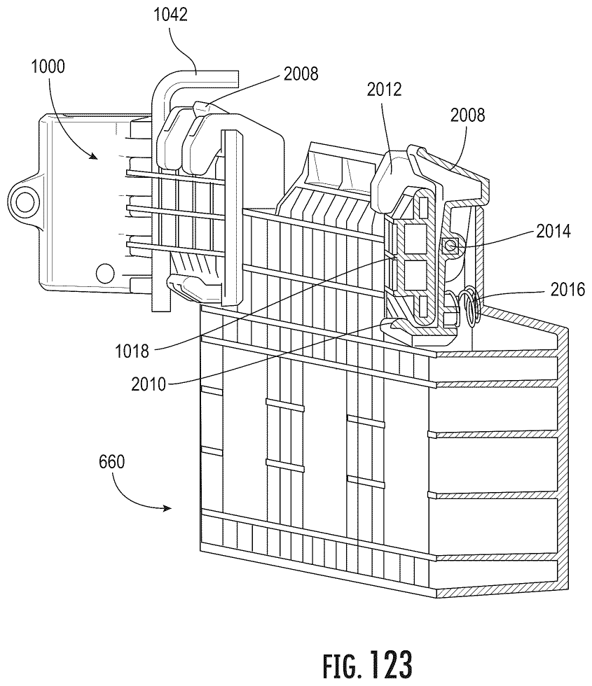

Rail 660 further includes opposing engagement ends. Each engagement end includes at least one clip 2012 and a spring loaded clip 2010 configured to securely couple to adapter 1000 and/or the utility modules (e.g., 10, 30, 40). As shown in the cross-sectional view of FIG. 123, a spring 2016 presses against spring loaded clip 2010 while a hinge pin 2014 secures spring loaded clip 2010 to accessory rail 660.

Spring loaded clip 2010 further includes an actuator, shown as button 2008. As will generally be understood, button 2008 can be actuated such that spring loaded clip 2010 pivots about hinge pin 2014. In such a manner, spring loaded clip 2010 can be moved and/or pulled away from front surface 2000 of accessory rail 660 to allow for engagement and release of adapters 1000. In particular, Applicant believes the shape of button 2008 allows a user to press and/or slide button 2008 relative to clip(s) 2012 from either a front direction or above allowing comfortable access regardless of the orientation of accessory rail 660.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. An adapter system for a utility module comprising:
an adapter comprising:
a front piece, the front piece comprising:
a body extending along a longitudinal axis of the adapter; and
one or more recessed sections positioned along the body;
a rear clamp, the rear clamp rotatably coupled to the front piece;
an engagement end;
a clamping end opposing the engagement end;
a bore defined by the front piece and the rear clamp, the bore positioned at the clamping end;
wherein the bore is configured to engage a corner post of the utility module.

2. The adapter system of claim 1, further comprising a storage device, the storage device coupled to and supported by the one or more recessed sections.

3. The adapter system of claim 1, wherein the one or more recessed sections extend inward, away from an outer edge of the body.

4. The adapter system of claim 1, wherein the body has a first width and the one or more recessed sections have a second width, and wherein the second width is less than the first width.

5. The adapter system of claim 1, the adapter further comprising a tab positioned at the engagement end of the body.

6. The adapter system of claim 5, wherein the tab is positioned at a distal end of the one or more recessed sections.

7. The adapter system of claim 1, wherein the storage device is a clip rail.

8. The adapter system of claim 7, wherein the clip rail comprises:
a first engagement end;
a second engagement end; and
a rail body extending between the first engagement end and the second engagement end;
wherein the first engagement end and the second engagement end each comprise at least one clip.

9. The adapter system of claim 8, wherein the clip rail further comprises at least one spring loaded clip positioned at the first engagement end or the second engagement end.

10. A utility module system comprising:
a utility module comprising:
a plurality of corners, the plurality of corners including upper and lower corners;
a side extending between and connecting the plurality of corners; and
a plurality of corner posts extending between and connecting the upper corners and the lower corners; and
a pair of adapters, each adapter coupled to one of the plurality of corner posts, each adapter comprising:
a first piece, the first piece comprising:
a longitudinally extending body extending along the side of the utility module; and
a recessed section extending along the longitudinally extending body;
a clamp, the clamp rotatably coupled to the first piece;
an engagement end; and
a clamping end opposing the engagement end.

11. The utility module system of claim 10, wherein a space is defined between the engagement ends of the pair of adapters.

12. The utility module system of claim 11, further comprising a storage device, the storage device supported by the pair of adapters such that storage device spans the space between the engagement ends.

13. The utility module system of claim 12, wherein the storage device is at least one of a hook, a tool pouch, and a clip rail.

14. The utility module system of claim 10, wherein the plurality of corners define the outermost edges of the utility module.

15. A side mount structure for a utility module comprising:
a first engagement end;
a second engagement end;
a longitudinally extending body extending between and connecting the first engagement end and the second engagement end;
a first wall extending outward from the longitudinally extending body;
a second wall extending outward from the longitudinally extending body;
a gate;
a storage compartment defined between the first wall, the second wall, and the gate;
wherein the gate is pivotable downward from a bottom surface of the first wall or the second wall;
wherein the first engagement end and second engagement end are configured to couple to a utility module.

16. The side mount structure of claim 15, wherein the gate is pivotable in a counterclockwise direction relative to the longitudinally extending body.

17. The side mount structure of claim 15, wherein the gate is pivotable between a closed positioned in which the gate extends between the first wall and the second wall such that an accessory is restrained by the gate, and an open position in which the accessory is removable from the storage compartment.

18. The side mount structure of claim 15, wherein the gate includes a first closed end and a second open end, wherein the open end is coupled to the second wall.

19. The side mount structure of claim 18, wherein a notch resists movement of the closed end of the gate relative to the first wall.

20. The side mount structure of claim 15, wherein the gate is a spring.
